(19) United States
(12) Patent Application Publication
(10) Pub. No.: US 2026/0274050 A1
(43) Pub. Date: Sep. 17, 2026

(54) Coating for Head-Up Display

(71) Applicant: Vitro Flat Glass LLC, Cheswick, PA (US)

(72) Inventors: Alexandra Gordienko, Natrona Heights, PA (US); Paul A. Medwick, Wexford, PA (US); Andrew V. Wagner, Pittsburgh, PA (US)

(21) Appl. No.: 19/565,651

(22) Filed: Mar. 13, 2026

Related U.S. Application Data
(60) Provisional application No. 63/772,918, filed on Mar. 17, 2025.

(51) Int. Cl. B60J 1/00; B32B 17/10; B60K 35/23; C03C 17/36; C09D 1/00; C09D 5/33

(52) U.S. Cl. CPC B60J 1/001; B32B 17/10036; B32B 17/10201; B32B 17/10229; B32B 17/10761; B60K 35/23; C03C 17/3644; C03C 17/366; C03C 17/3681; C09D 1/00; C09D 5/004; C03C 2217/211; C03C 2217/216; C03C 2217/23; C03C 2217/256; C03C 2218/156

(57) ABSTRACT

Coated articles, laminates, and windshields having enhanced p-polarized radiation reflecting properties are provided. The coated articles, laminates, and windshields include a functional coating positioned over at least a portion of a substrate. The functional coating includes a first dielectric layer comprising a first film and a second film, a first metallic layer, a second dielectric layer, a second metallic layer, and a third dielectric layer. The functional coating is configured to reflect at least 10% of p-polarized radiation that contacts the functional coating at an incident angle of 60° relative to normal of the coated article, laminate, or windshield. Also provided herein are a method of projecting an image in a head-up display, a vehicle head-up display system, and a vehicle including the head-up display system.

### CROSS REFERENCE TO RELATED APPLICATIONS

This application claims priority to U.S. Provisional Application No. 63/772,918, filed Mar. 17, 2025, the disclosure of which is incorporated by reference herein in its entirety.

### BACKGROUND OF THE INVENTION

### Field of the Invention

The present invention relates to a coated article, a method of making a coated article, a method of projecting an image in a heads-up display, a vehicle heads-up display system, and a vehicle comprising a heads-up display system. In particular, the present invention relates to coated articles, laminates, or windshields having a functional coating that is configured to reflect at least 10% of p-polarized radiation that contacts the functional coating at an incident angle of 60° relative to normal of the coated article, laminate, or windshield, wherein the functional coating reflects the p-polarized radiation at a reflected angle ranging from 40° to 70° relative to normal of the coated article, laminate, or windshield.

### Technical Considerations

Conventional automotive head-up displays (HUDs) use an electromagnetic radiation source mounted in the dashboard that projects radiation onto the windshield, which is then reflected to the driver's eyes, creating a virtual image of vehicle data so that the driver has access to information about the vehicle's operation without having to look away from the road. For electromagnetic radiation reflecting off of the windshield at angles typically found in a conventional vehicle and a typical unpolarized radiation source (e.g., a light emitting diode), the reflected radiation primarily is s-polarized radiation, with a much smaller component of the radiation being p-polarized. If the angle of incidence of the electromagnetic radiation directed towards the windshield is the Brewster's angle of an air to glass interface (approximately 57°), the p-polarized reflectance is zero percent.

Radiation from the radiation source, which is primarily s-polarized radiation, will reflect at least off of both the innermost surface and the outermost surface of the windshield due to the refractive index mismatch between air and glass, leading to at least two reflected images being formed (one from each surface). Multiple images formed in a HUD is a phenomenon referred to as “ghosting” and eliminating or minimizing the presence of “ghosts” is a goal of HUD technology.

A conventional method of resolving ghosting is by positioning a wedge-shaped interlayer between the inner and outer glass plies of the windshield to adjust the geometry of the two glass plies to align the two reflected images. This wedge-shaped interlayer increases the cost of the windshield and also increases the complexity of manufacturing the windshield.

Coatings that provide solar control, heating, and/or antenna functionality can be present on at least one of the glass plies of a windshield. However, these additional coatings lead to a third refractive index mismatch within the windshield, leading to a third reflection and therefore, a third reflected image on the HUD system. This third reflected image is difficult to be compensated for by a wedge-shaped interlayer.

Furthermore, many drivers wear polarized sunglasses to reduce glare from the road and other sources while driving. Typical polarized sunglasses block s-polarized radiation, but allow p-polarized radiation to pass through polarized lenses. However, as mentioned above, in conventional HUD systems, s-polarized radiation is primarily what reflects off of the windshield to form the image of the HUD, while very little p-polarized radiation is reflected off of the windshield. This is especially true considering that the windshield is typically positioned at an angle near the Brewster's angle for the air to glass interface. Therefore, a driver wearing polarized sunglasses may not be able to see the image of the HUD that is formed by the primarily s-polarized radiation.

Therefore, there is a need in the art for a system and/or components to reduce or eliminate one or more of these problems. For example, it would be desirable to provide a HUD system that projects an image viewable to drivers that wear polarized sunglasses and/or that reduces or eliminates ghosting.

### SUMMARY OF THE INVENTION

The invention is directed to a coated article. The coated article comprises a first substrate having a No. 1 surface and a No. 2 surface opposite the No. 1 surface and a functional coating positioned over at least a portion of the No. 2 surface. The functional coating comprises: a first dielectric layer over at least a portion of the No. 2 surface, wherein the first dielectric layer comprises a first film comprising tin oxide and a second film over at least a portion of the first film, and wherein the first dielectric layer comprises a total thickness in a range of from 299 Angstroms (Å) to 447 Å; a first metallic layer over at least a portion of the first dielectric layer, wherein the first metallic layer comprises a thickness in a range of from 125 Å to 162 Å; a second dielectric layer over at least a portion of the first metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å. The functional coating is configured to reflect at least 10% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

In another embodiment, the invention is directed to a method of making a coated article. The method comprises: providing a substrate having a No. 1 surface and a No. 2 surface opposite the No. 1 surface and applying a functional coating over at least a portion of the No. 2 surface. Applying the functional coating comprises: forming a first dielectric layer over at least a portion of the No. 2 surface, wherein forming the first dielectric layer comprises: forming a first film comprising tin oxide over at least a portion of the No. 2 surface, and forming a second film over at least a portion of the first film, wherein the first dielectric layer comprises a total thickness in a range of from 299 Å to 447 Å; forming a first metallic layer over at least a portion of the first dielectric layer, wherein the first metallic layer comprises a thickness in a range of from 125 Å to 162 Å; forming a second dielectric layer over at least a portion of the first metallic layer, wherein the second dielectric layer comprises a total thickness in a range of from 835 Å to 1052 Å; forming a second metallic layer over at least a portion of the second dielectric layer, wherein the second metallic layer comprises a thickness in a range of from 70 Å to 95 Å; and forming a third dielectric layer over at least a portion of the second metallic layer, wherein the third dielectric layer comprises a total thickness in a range of from 315 Å to 410 Å. The functional coating is configured to reflect at least 10.0% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

In another embodiment, the invention is directed to a method of projecting an image in a head-up display. The method comprises: providing a laminate, wherein the laminate comprises: a first substrate comprising a No. 1 surface and a No 2. surface opposite the No. 1 surface; a second substrate comprising a No. 3 surface and a No. 4 surface opposite the No. 3 surface, wherein the No. 2 surface faces the No. 3 surface, and an interlayer positioned between the No. 2 surface and the No. 3 surface; and a functional coating positioned over at least a portion of the No. 2 surface or the No. 3 surface, wherein the functional coating comprises: a first dielectric layer over at least a portion of the No. 2 surface or the No. 3 surface, wherein the first dielectric layer comprises a first film comprising tin oxide over at least a portion of the No. 2 surface or the No. 3 surface and a second film over at least a portion of the first film, and wherein the first dielectric layer comprises a total thickness in a range of from 299 Å to 447 Å; a first metallic layer over at least a portion of the first dielectric layer, wherein the first metallic layer comprises a thickness in a range of from 125 Å to 162 Å; a second dielectric layer over at least a portion of the metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å; and directing a radiation source emitting p-polarized radiation at an area of an inner side of the laminate, wherein the radiation source is positioned at an angle of 60° relative to normal of the laminate. The functional coating is configured to reflect at least 10% the p-polarized radiation that contacts the functional coating at an incident angle of 60° relative to normal of the laminate, wherein the functional coating reflects the p-polarized radiation at a reflected angle ranging from 40° to 70° relative to normal of the laminate. The radiation emitted from the radiation source is reflected as an image through the No. 4 surface.

In another embodiment, the invention is directed to a vehicle head-up display system. The vehicle head-up display system comprises a radiation source and a windshield comprising: a first substrate having a No. 1 surface and a No. 2 surface opposite the No. 1 surface; a second substrate having a No. 3 surface and a No. 4 surface opposite the No. 3 surface; an interlayer positioned between the No. 2 surface and the No. 3 surface; and a functional coating positioned on the No. 3 surface, the functional coating comprising: a first dielectric layer over at least a portion of the No. 3 surface, wherein the first dielectric layer comprises a first film comprising tin oxide over at least a portion of the No. 3 surface and a second film over at least a portion of the first film, and wherein the first dielectric layer comprises a total thickness in a range of from 299 Å to 447 Å; a first metallic layer over at least a portion of the first dielectric layer, wherein the first metallic layer comprises a thickness in a range of from 125 Å to 162 Å; a second dielectric layer over at least a portion of the metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å. The radiation source is configured to emit radiation comprising p-polarized radiation at an incident angle of 60° relative to normal of the windshield. The functional coating is configured to reflect at least 10.0% of the p-polarized radiation at a reflected angle ranging from 40° to 70° relative to normal of the windshield.

In another embodiment, the invention is directed to a vehicle comprising a head-up display system. The head-up display system comprises a radiation source positioned in a front dashboard or a proximate location of the vehicle and a windshield comprising: a first substrate having a No. 1 surface and a No. 2 surface opposite the No. 1 surface; a second substrate having a No. 3 surface and a No. 4 surface opposite the No. 3 surface; an interlayer positioned between the No. 2 surface and the No. 3 surface; and a functional coating positioned on the No. 3 surface. The functional coating comprises: a first dielectric layer over at least a portion of No. 3 surface, wherein the first dielectric layer comprises a first film comprising tin oxide over at least a portion of the No. 3 surface and a second film over at least a portion of the first film, and wherein the first dielectric layer comprises a total thickness in a range of from 299 Å to 447 Å; a first metallic layer over at least a portion of the first dielectric layer, wherein the first metallic layer comprises a thickness in a range of from 125 Å to 162 Å; a second dielectric layer over at least a portion of the metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å. The radiation source is configured to emit radiation comprising p-polarized radiation at an incident angle of 60° relative to normal of the windshield. The functional coating is configured to reflect at least 10.0% of the p-polarized radiation at a reflected angle ranging from 40° to 70° relative to normal of the laminate. The radiation emitted from the radiation source is reflected as an image through the No. 4 surface.

This disclosure is further described in the following numbered clauses:

Clause 1: A coated article comprising: a first substrate having a No. 1 surface and a No. 2 surface opposite the No. 2 surface; and a functional coating positioned over at least a portion of the No. 2 surface, the functional coating comprising: a first dielectric layer over at least a portion of the No. 2 surface, wherein the first dielectric layer comprises a first film comprising tin oxide and a second film over at least a portion of the first film, and wherein the first dielectric layer comprises a total thickness in a range of from 299 Angstroms (Å) to 447 Å; a first metallic layer over at least a portion of the first dielectric layer, wherein the first metallic layer comprises a thickness in a range of from 125 Å to 162 Å; a second dielectric layer over at least a portion of the first metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å; wherein the functional coating is configured to reflect at least 10% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

Clause 2: The coated article of clause 1, wherein the functional coating is configured to reflect at least 13%, or such as at least 13.5%, of p-polarized radiation that contacts the functional coating at the incident angle of 60° relative to normal of the substrate, wherein the functional coating reflects the p-polarized radiation at the reflected angle ranging from 40° to 70° relative to normal of the coated article.

Clause 3: The coated article of clause 1 or 2, wherein the p-polarized radiation comprises wavelengths ranging from 445 nanometers (nm) to 654 nm.

Clause 4: The coated article of any one of clauses 1 to 3, wherein the functional coating consists of two metallic layers.

Clause 5: The coated article of any one of clauses 1 to 4, wherein the second film of the first dielectric layer comprises zinc oxide.

Clause 6: The coated article of any one of clauses 1 to 5, wherein the first film of the first dielectric layer comprises a thickness in a range of from 235 Å to 365 Å, such as from 245 Å to 355 Å, such as from 255 Å to 345 Å, or such as from 258 Å to 265 Å, and wherein the second film of the first dielectric layer comprises a thickness in a range of from 64 Å to 82 Å, such as from 66 Å to 80 Å, such as from 68 Å to 78 Å, or such as from 70 Å to 76 Å.

Cause 7: The coated article of any one of clauses 1 to 4, wherein the first dielectric layer further comprises a third film over at least a portion of the second film.

Clause 8: The coated article of clause 7, wherein when the first dielectric layer comprises the third film over at least a portion of the second film, the first film comprises tin oxide, the second film comprises zinc stannate, and the third film comprises zinc oxide.

Clause 9: The coated article of clause 8, wherein the first film of the first dielectric layer comprises a thickness in a range of from 145 Å to 195 Å, such as from 150 Å to 190 Å, such as from 157 Å to 180 Å, or such as from 159 Å to 163 Å, wherein the second film of the first dielectric layer comprises a thickness in a range of from 90 Å to 170 Å, such as from 95 Å to 165 Å, such as from 98 Å to 165 Å, or such as from 99 Å to 102 Å, and wherein the third film of the first dielectric layer comprises a thickness in a range of from 64 Å to 82 Å, such as from 66 Å to 80 Å, such as from 68 Å to 78 Å, or such as from 70 Å to 76 Å.

Clause 10: The coated article of any one of clauses 1 to 9, wherein the first dielectric layer comprises a total thickness in a range of from 311 Å to 435 Å, such as from 323 Å to 423 Å, or such as from 328 Å to 341 Å.

Clause 11: The coated article of any one of clauses 1 to 10, wherein the first metallic layer comprises metallic gold, copper, palladium, aluminum, silver, or mixtures, alloys, or combinations thereof.

Clause 12: The coated article of any one of clauses 1 to 11, wherein the first metallic layer comprises silver.

Clause 13: The coated article of any one of clauses 1 to 12, wherein the first metallic layer comprises a thickness in a range of from 130 Å to 158 Å, such as from 135 Å to 153 Å, or such as from 144 Å to 148 Å.

Clause 14: The coated article of any one of clauses 1 to 13, wherein the functional coating further comprises a first primer layer over at least a portion of the first metallic layer.

Clause 15: The coated article of clause 14, wherein the first primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the first primer layer is deposited as a metal and subsequently oxidized.

Clause 16: The coated article of clause 14 or 15, wherein the first primer layer comprises aluminum zinc.

Clause 17: The coated article of any one of clauses 14 to 16, wherein the first primer layer comprises a thickness in a range of from 5 Å to 60 Å, such as from 8 Å to 50 Å, such as from 10 Å to 40 Å, or such as from 15 Å to 25 Å.

Clause 18: The coated article of any one of clauses 1 to 17, wherein the second dielectric layer comprises a first film over at least a portion of the first metallic layer, a second film over at least a portion of the first film, and a third film over at least a portion of the second film.

Clause 19: The coated article of clause 18, wherein the first film of the second dielectric layer comprises zinc oxide.

Clause 20: The coated article of clause 18 or 19, wherein the first film of the second dielectric layer comprises a thickness in a range of from 105 Å to 130 Å, such as from 108 Å to 128 Å, such as from 110 Å to 125 Å, or such as from 115 Å to 122 Å.

Clause 21: The coated article of clause 18, wherein the second film of the second dielectric layer comprises zinc stannate.

Clause 22: The coated article of clause 18 or 21, wherein the second film of the second dielectric layer comprises a thickness in a range of from 640 Å to 810 Å, such as from 660 Å to 790 Å, such as from 680 Å to 770 Å, or such as from 685 Å to 715 Å.

Clause 23: The coated article of clause 18, wherein the third film of the second dielectric layer comprises zinc oxide.

Clause 24: The coated article of clause 18 or 23, wherein the third film of the second dielectric layer comprises a thickness in a range of from 90 Å to 112 Å, such as from 92 Å to 110 Å, such as from 95 Å to 107 Å, or such as from 98 Å to 103 Å.

Clause 25: The coated article of any one of clauses 1 to 24, wherein the second dielectric layer comprises a total thickness in a range of from 860 Å to 1028 Å, such as from 885 Å to 1002 Å, or such as from 898 Å to 940 Å.

Clause 26: The coated article of any one of clauses 1 to 25, wherein the second metallic layer comprises metallic gold, copper, palladium, aluminum, silver, or mixtures, alloys, or combinations thereof.

Clause 27: The coated article of any one of clauses 1 to 26, wherein the second metallic layer comprises silver.

Clause 28: The coated article of any one of clauses 1 to 27, wherein the second metallic layer comprises a thickness in a range of from 72 Å to 90 Å, such as from 75 Å to 88 Å, or such as from 79 Å to 84 Å.

Clause 29: The coated article of any one of clauses 1 to 28, wherein the functional coating further comprises a second primer layer over at least a portion of the second metallic layer.

Clause 30: The coated article of clause 29, wherein the second primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the second primer layer is deposited as a metal and subsequently oxidized.

Clause 31: The coated article of clause 29 or 30, wherein the second primer layer comprises aluminum zinc.

Clause 32: The coated article of any one of clauses 29 to 31, wherein the second primer layer comprises a thickness in a range of from 5 Å to 60 Å, such as from 8 Å to 50 Å, such as from 10 Å to 40 Å, or such as from 15 Å to 35 Å.

Clause 33: The coated article of any one of clauses 1 to 32, wherein the third dielectric layer comprises a first film over at least a portion of the second metallic layer and a second film over at least a portion of the first film.

Clause 34: The coated article of clause 33, wherein the first film of the third dielectric layer comprises zinc oxide.

Clause 35: The coated article of clause 33 or 34, wherein the first film of the third dielectric layer comprises a thickness in a range of from 65 Å to 80 Å, such as from 68 Å to 78 Å, such as from 70 Å to 76 Å, or such as from 71 Å to 74 Å.

Clause 36: The coated article of clause 33, wherein the second film of the third dielectric layer comprises zinc stannate or tin oxide.

Clause 37: The coated article of clause 33 or 36, wherein the second film of the third dielectric layer comprises a thickness in a range of from 250 Å to 330 Å, such as from 260 Å to 320 Å, such as from 270 Å to 310 Å, or such as from 275 Å to 280 Å.

Clause 38: The coated article of any one of clauses 1 to 37, wherein the third dielectric layer comprises a total thickness in a range of from 328 Å to 398 Å, such as from 340 Å to 386 Å, or such as from 346 Å to 354 Å.

Clause 39: The coated article of any one of clauses 1 to 38, further comprising an outermost protective coating over at least a portion of the functional coating, wherein the outermost protective coating comprises at least one protective layer.

Clause 40: The coated article of clause 39, wherein the at least one protective layer comprises at least one of Si₃N₄, SiON, SiAlN, SiAlON, titania, alumina, silica, or zirconia.

Clause 41: The coated article of clause 39, wherein the outermost protective coating comprises a first protective layer over at least a portion of the third dielectric layer and a second protective layer over at least a portion of the first protective layer.

Clause 42: The coated article of clause 41, wherein the first protective layer comprises SiAl and the second protective layer comprises SiO₂.

Clause 43: The coated article of any one of clauses 39 to 42, wherein the outermost protective coating comprises a thickness in a range of from 495 Å to 610 Å, such as from 515 Å to 590 Å, such as from 525 Å to 580 Å, or such as from 535 Å to 570 Å.

Clause 44: The coated article of any one of clauses 1 to 43, wherein the coated article comprises a veiling glare, as determined relative to normal of the coated article, of less than or equal to 22%, such as less than or equal to 20%, or such as less than equal to 19%.

Clause 45: The coated article of any one of clauses 1 to 44, wherein the functional coating is configured to reflect at least 10.0% and no more than 20.0% of p-polarized radiation that contacts the functional coating at the incident angle of 60° relative to normal of the coated article, wherein the functional coating reflects the p-polarized radiation at the reflected angle ranging from 40° to 70° relative to normal of the coated article, wherein the reflected p-polarized radiation comprises wavelengths ranging from 646 nm to 654 nm.

Clause 46: The coated article of any one of clauses 1 to 45, wherein the functional coating is configured to reflect at least 10.0% and no more than 20.0% of p-polarized radiation that contacts the functional coating at the incident angle of 60° relative to normal of the coated article, wherein the functional coating reflects the p-polarized radiation at the reflected angle ranging from 40° to 70° relative to normal of the coated article, wherein the reflected p-polarized radiation comprises wavelengths ranging from 515 nm to 525 nm.

Clause 47: The coated article of any one of clauses 1 to 46, wherein the functional coating is configured to reflect at least 10.0% and no more than 21.5% of p-polarized radiation that contacts the functional coating at the incident angle of 60° relative to normal of the coated article, wherein the functional coating reflects the p-polarized radiation at the reflected angle ranging from 40° to 70° relative to normal of the coated article, wherein the reflected p-polarized radiation comprises wavelengths ranging from 445 nm to 465 nm.

Clause 48: The coated article of any one of clauses 1 to 47, wherein the coated article comprises a visible light transmittance (LTA) of at least 70%.

Clause 49: The coated article of any one of clauses 1 to 48, wherein the coated article comprises a RgL* value of no more than 55, as determined relative to normal of the coated article.

Clause 50: The coated article of any one of clauses 1 to 49, further comprising a second substrate comprising a No. 3 surface and a No. 4 surface opposite the No. 3 surface, and an interlayer positioned between and in direct contact with the No. 3 surface and the functional coating on the No. 2 surface.

Clause 51: The coated article of clause 50, wherein the coated article is a windshield.

Clause 52: A method of making a coated article, the method comprising: providing a first substrate having a No. 1 surface and a No. 2 surface opposite the No. 1 surface; applying a functional coating over at least a portion of the No. 2 surface, wherein applying the functional coating comprises: forming a first dielectric layer over at least a portion of the No. 2 surface, wherein forming the first dielectric layer comprises: forming a first film comprising tin oxide over at least a portion of the No. 2 surface, and forming a second film over at least a portion of the first film, wherein the first dielectric layer comprises a total thickness in a range of from 299 Å to 447 Å; forming a first metallic layer over at least a portion of the first dielectric layer, wherein the first metallic layer comprises a thickness in a range of from 125 Å to 162 Å; forming a second dielectric layer over at least a portion of the first metallic layer, wherein the second dielectric layer comprises a total thickness in a range of from 835 Å to 1052 Å; forming a second metallic layer over at least a portion of the second dielectric layer, wherein the second metallic layer comprises a thickness in a range of from 70 Å to 95 Å; and forming a third dielectric layer over at least a portion of the second metallic layer, wherein the third dielectric layer comprises a total thickness in a range of from 315 Å to 410 Å; wherein the functional coating is configured to reflect at least 10.0% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

Clause 53: The method of clause 52, wherein the functional coating is configured to reflect at least 13.5% of p-polarized radiation that contacts the functional coating at the incident angle of 60° relative to normal of the coated article, wherein the functional coating reflects the p-polarized radiation at the reflected angle ranging from 40° to 70° relative to normal of the coated article.

Clause 54: The method of clause 52 or 53, wherein the p-polarized radiation comprises wavelengths ranging from 445 nm to 654 nm.

Clause 55: The method of any one of clauses 52 to 54, wherein the functional coating consists of two metallic layers.

Clause 56: The method of any one of clauses 52 to 55, wherein the second film of the first dielectric layer comprises zinc oxide.

Clause 57: The method of any one of clauses 52 to 56, wherein the first film of the first dielectric layer comprises a thickness in a range of from 235 Å to 365 Å, such as from 245 Å to 355 Å, such as from 255 Å to 345 Å, or such as from 258 Å to 265 Å, and wherein the second film of the first dielectric layer comprises a thickness in a range of from 64 Å to 82 Å, such as from 66 Å to 80 Å, such as from 68 Å to 78 Å, or such as from 70 Å to 76 Å.

Clause 58: The method of any one of clauses 52 to 55, wherein forming the first dielectric layer further comprises forming a third film over at least a portion of the second film.

Clause 59: The method of clause 58, wherein when the first dielectric layer comprises the third film over at least a portion of the second film, the first film comprises tin oxide, the second film comprises zinc stannate, and the third film comprises zinc oxide.

Clause 60: The method of clause 58 or 59, wherein the first film of the first dielectric layer comprises a thickness in a range of from 145 Å to 195 Å, such as from 150 Å to 190 Å, such as from 157 Å to 180 Å, or such as from 159 Å to 163 Å, wherein the second film of the first dielectric layer comprises a thickness in a range of from 90 Å to 170 Å, such as from 95 Å to 165 Å, such as from 98 Å to 165 Å, or such as from 99 Å to 102 Å, and wherein the third film of the first dielectric layer comprises a thickness in a range of from 64 Å to 82 Å, such as from 66 Å to 80 Å, such as from 68 Å to 78 Å, or such as from 70 Å to 76 Å.

Clause 61: The method of any one of clauses 52 to 60, wherein the first dielectric layer comprises a total thickness in a range of from 311 Å to 435 Å, such as from 323 Å to 423 Å, or such as from 328 Å to 341 Å.

Clause 62: The method of any one of clause 52 to 61, wherein the first metallic layer comprises metallic gold, copper, palladium, aluminum, silver, or mixtures, alloys, or combinations thereof.

Clause 63: The method of any one of clauses 52 to 62, wherein the first metallic layer comprises silver.

Clause 64: The method of any one of clauses 52 to 63, wherein the first metallic layer comprises a thickness in a range of from 130 Å to 158 Å, such as from 135 Å to 153 Å, or such as from 144 Å to 148 Å.

Clause 65: The method of any one of clauses 52 to 64, further comprising forming a first primer layer over at least a portion of the first metallic layer.

Clause 66: The method of clause 65, wherein the first primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the first primer layer is deposited as a metal and subsequently oxidized.

Clause 67: The method of clause 65 or 66, wherein the first primer layer comprises aluminum zinc.

Clause 68: The method of any one of clauses 65 to 67, wherein the first primer layer comprises a thickness in a range of from 5 Å to 60 Å, such as from 8 Å to 50 Å, such as from 10 Å to 40 Å, or such as from 15 Å to 25 Å.

Clause 69: The method of any one of clauses 52 to 68, wherein forming the second dielectric layer comprises forming a first film over at least a portion of the first metallic layer, forming a second film over at least a portion of the first film, and forming a third film over at least a portion of the second film.

Clause 70: The method of clause 69, wherein the first film of the second dielectric layer comprises zinc oxide.

Clause 71: The method of clause 69 or 70, wherein the first film of the second dielectric layer comprises a thickness in a range of from 105 Å to 130 Å, such as from 108 Å to 128 Å, such as from 110 Å to 125 Å, or such as from 115 Å to 122 Å.

Clause 72: The method of clause 69, wherein the second film of the second dielectric layer comprises zinc stannate.

Clause 73: The method of clause 69 or 72, wherein the second film of the second dielectric layer comprises a thickness in a range of from 640 Å to 810 Å, such as from 660 Å to 790 Å, such as from 680 Å to 770 Å, or such as from 685 Å to 715 Å.

Clause 74: The method of clause 69, wherein the third film of the second dielectric layer comprises zinc oxide.

Clause 75: The method of clause 69 or 74, wherein the third film of the second dielectric layer comprises a thickness in a range of from 90 Å to 112 Å, such as from 92 Å to 110 Å, such as from 95 Å to 107 Å, or such as from 98 Å to 103 Å.

Clause 76: The method of any one of clauses 52 to 75, wherein the second dielectric layer comprises a total thickness in a range of from 860 Å to 1028 Å, such as from 885 Å to 1002 Å, or such as from 898 Å to 940 Å.

Clause 77: The method of any one of clauses 52 to 76, wherein the second metallic layer comprises metallic gold, copper, palladium, aluminum, silver, or mixtures, alloys, or combinations thereof.

Clause 78: The method of any one of clauses 52 to 77, wherein the second metallic layer comprises silver.

Clause 79: The method of any one of clauses 52 to 78, wherein the second metallic layer comprises a thickness in a range of from 72 Å to 90 Å, such as from 75 Å to 88 Å, or such as from 79 Å to 84 Å.

Clause 80: The method of any one of clauses 52 to 79, further comprising forming a second primer layer over at least a portion of the second metallic layer.

Clause 81: The method of clause 80, wherein the second primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the second primer layer is deposited as a metal and subsequently oxidized.

Clause 82: The method of clause 80 or 81, wherein the second primer layer comprises aluminum zinc.

Cause 83: The method of any one of clauses 80 to 82, wherein the second primer layer comprises a thickness in a range of from 5 Å to 60 Å, such as from 8 Å to 50 Å, such as from 10 Å to 40 Å, or such as from 15 Å to 35 Å.

Clause 84: The method of any one of clauses 52 to 83, wherein forming the third dielectric layer comprises forming a first film over at least a portion of the second metallic layer and forming a second film over at least a portion of the first film.

Clause 85: The method of clause 84, wherein the first film of the third dielectric layer comprises zinc oxide.

Clause 86: The method of clause 84 or 85, wherein the first film of the third dielectric layer comprises a thickness in a range of from 65 Å to 80 Å, such as from 68 Å to 78 Å, such as from 70 Å to 76 Å, or such as from 71 Å to 74 Å.

Clause 87: The method of clause 84, wherein the second film of the third dielectric layer comprises zinc stannate or tin oxide.

Clause 88: The method of clause 84 or 87, wherein the second film of the third dielectric layer comprises a thickness in a range of from 250 Å to 330 Å, such as from 260 Å to 320 Å, such as from 270 Å to 310 Å, or such as from 275 Å to 280 Å.

Clause 89: The method of any one of clauses 52 to 88, wherein the third dielectric layer comprises a total thickness in a range of from 328 Å to 398 Å, such as from 340 Å to 386 Å, or such as from 346 Å to 354 Å.

Clause 90: The method of any one of clauses 52 to 89, further comprising forming an outermost protective coating over at least a portion of the functional coating, wherein the outermost protective coating comprises at least one protective layer.

Clause 91: The method of clause 90, wherein the at least one protective layer comprises at least one of Si₃N₄, SiON, SiAlN, SiAlON, titania, alumina, silica, or zirconia.

Clause 92: The method of clause 90, wherein the outermost protective coating comprises a first protective layer over at least a portion of the third dielectric layer and a second protective layer over at least a portion of the first protective layer.

Clause 93: The method of clause 92, wherein the first protective layer comprises SiAl and the second protective layer comprises SiO₂.

Clause 94: The method of any one of clauses 90 to 93, wherein the outermost protective coating comprises a thickness in a range of from 495 Å to 610 Å, such as from 515 Å to 590 Å, such as from 525 Å to 580 Å, or such as from 535 Å to 570 Å.

Clause 95: The method of any one of clauses 52 to 94, wherein the coated article comprises a veiling glare, as determined relative to normal of the coated article, of less than or equal to 22%, such as less than or equal to 20%, or such as less than equal to 19%.

Clause 96: The method of any one of clauses 52 to 95, wherein the functional coating is configured to reflect at least 10.0% and no more than 20.0% of p-polarized radiation that contacts the functional coating at the incident angle of 60° relative to normal of the coated article, wherein the functional coating reflects p-polarized radiation at the reflected angle ranging from 40° to 70° relative to normal of the coated article, wherein the reflected p-polarized radiation comprises wavelengths ranging from 646 nm to 654 nm.

Clause 97: The method of any one of clauses 52 to 96, wherein the functional coating is configured to reflect at least 10.0% and no more than 20.0% of p-polarized radiation that contacts the functional coating at the incident angle of 60° relative to normal of the coated article, wherein the functional coating reflects p-polarized radiation at the reflected angle ranging from 40° to 70° relative to normal of the coated article, wherein the reflected p-polarized radiation comprises wavelengths ranging from 515 nm to 525 nm.

Clause 98: The method of any one of clauses 52 to 97, wherein the functional coating is configured to reflect at least 10.0% and no more than 21.5% of p-polarized radiation that contacts the functional coating at the incident angle of 60° relative to normal of the coated article, wherein the functional coating reflects p-polarized radiation at the reflected angle ranging from 40° to 70° relative to normal of the coated article, wherein the reflected p-polarized radiation comprises wavelengths ranging from 445 nm to 465 nm.

Clause 99: The method of any one of clauses 52 to 98, wherein the coated article comprises a visible light transmittance (LTA) of at least 70%.

Clause 100: The method of any one of clauses 52 to 99, wherein the coated article comprises a RgL* value of no more than 55, as determined relative to normal of the coated article.

Clause 101: The method of any one of clauses 52 to 100, further comprising: providing a second substrate comprising a No. 3 surface and a No. 4 surface opposite the No. 3 surface, and positioning an interlayer between and in direct contact with the No. 3 surface and the functional coating on the No. 2 surface.

Clause 102: The method of clause 101, wherein the coated article is a windshield.

Clause 103: A method of projecting an image in a head-up display, the method comprising: providing a laminate, wherein the laminate comprises: a first substrate comprising a No. 1 surface and a No 2. surface opposite the No. 1 surface; a second substrate comprising a No. 3 surface and a No. 4 surface opposite the No. 3 surface, wherein the No. 2 surface faces the No. 3 surface, an interlayer positioned between the No. 2 surface and the No. 3 surface; and a functional coating positioned over at least a portion of the No. 2 surface or the No. 3 surface, the functional coating comprising: a first dielectric layer over at least a portion of the No. 2 surface or the No. 3 surface, wherein the first dielectric layer comprises a first film comprising tin oxide over at least a portion of the No. 2 surface or the No. 3 surface and a second film over at least a portion of the first film, and wherein the first dielectric layer comprises a total thickness in a range of from 299 Å to 447 Å; a first metallic layer over at least a portion of the first dielectric layer, wherein the first metallic layer comprises a thickness in a range of from 125 Å to 162 Å; a second dielectric layer over at least a portion of the metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å; and directing a radiation source emitting p-polarized radiation at an area of an inner side of the laminate, wherein the radiation source is positioned at an angle of 60° relative to normal of the laminate, wherein the functional coating is configured to reflect at least 10% the p-polarized radiation that contacts the functional coating at an incident angle of 60° relative to normal of the laminate, wherein the functional coating reflects the p-polarized radiation at a reflected angle ranging from 40° to 70° relative to normal of the laminate, and wherein the radiation emitted from the radiation source is reflected as an image through the No. 4 surface.

Clause 104: The method of clause 103, wherein the functional coating is configured to reflect at least 13.5% of p-polarized radiation that contacts the functional coating at the incident angle of 60° relative to normal of the laminate, wherein the functional coating reflects the p-polarized radiation at the reflected angle ranging from 40° to 70° relative to normal of the laminate.

Clause 105: The method of clause 103 or 104, wherein the p-polarized radiation comprises wavelengths ranging from 445 nm to 654 nm.

Clause 106: The method of any one of clauses 103 to 105, wherein the functional coating consists of two metallic layers.

Clause 107: The method of any one of clauses 103 to 106, wherein the second film of the first dielectric layer comprises zinc oxide.

Clause 108: The method of any one of clauses 103 to 107, wherein the first film of the first dielectric layer comprises a thickness in a range of from 235 Å to 365 Å, such as from 245 Å to 355 Å, such as from 255 Å to 345 Å, or such as from 258 Å to 265 Å, and wherein the second film of the first dielectric layer comprises a thickness in a range of from 64 Å to 82 Å, such as from 66 Å to 80 Å, such as from 68 Å to 78 Å, or such as from 70 Å to 76 Å.

Clause 109: The method of any one of clauses 103 to 107, wherein forming the first dielectric layer further comprises forming a third film over at least a portion of the second film.

Clause 110: The method of clause 109, wherein when the first dielectric layer comprises the third film over at least a portion of the second film, the first film comprises tin oxide, the second film comprises zinc stannate, and the third film comprises zinc oxide.

Clause 111: The method of clause 109 or 110, wherein the first film of the first dielectric layer comprises a thickness in a range of from 145 Å to 195 Å, such as from 150 Å to 190 Å, such as from 157 Å to 180 Å, or such as from 159 Å to 163 Å, wherein the second film of the first dielectric layer comprises a thickness in a range of from 90 Å to 170 Å, such as from 95 Å to 165 Å, such as from 98 Å to 165 Å, or such as from 99 Å to 102 Å, and wherein the third film of the first dielectric layer comprises a thickness in a range of from 64 Å to 82 Å, such as from 66 Å to 80 Å, such as from 68 Å to 78 Å, or such as from 70 Å to 76 Å.

Clause 112: The method of any one of clauses 103 to 111, wherein the first dielectric layer comprises a total thickness in a range of from 311 Å to 435 Å, such as from 323 Å to 423 Å, or such as from 328 Å to 341 Å.

Clause 113: The method of any one of clause 103 to 112, wherein the first metallic layer comprises metallic gold, copper, palladium, aluminum, silver, or mixtures, alloys, or combinations thereof.

Clause 114: The method of any one of clauses 103 to 113, wherein the first metallic layer comprises silver.

Clause 115: The method of any one of clauses 103 to 114, wherein the first metallic layer comprises a thickness in a range of from 130 Å to 158 Å, such as from 135 Å to 153 Å, or such as from 144 Å to 148 Å.

Clause 116: The method of any one of clauses 103 to 115, further comprising forming a first primer layer over at least a portion of the first metallic layer.

Clause 117: The method of clause 116, wherein the first primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the first primer layer is deposited as a metal and subsequently oxidized.

Clause 118: The method of clause 116 or 117, wherein the first primer layer comprises aluminum zinc.

Clause 119: The method of any one of clauses 116 to 118, wherein the first primer layer comprises a thickness in a range of from 5 Å to 60 Å, such as from 8 Å to 50 Å, such as from 10 Å to 40 Å, or such as from 15 Å to 25 Å.

Clause 120: The method of any one of clauses 103 to 119, wherein forming the second dielectric layer comprises forming a first film over at least a portion of the first metallic layer, forming a second film over at least a portion of the first film, and forming a third film over at least a portion of the second film.

Clause 121: The method of clause 120, wherein the first film of the second dielectric layer comprises zinc oxide.

Clause 122: The method of clause 120 or 121, wherein the first film of the second dielectric layer comprises a thickness in a range of from 105 Å to 130 Å, such as from 108 Å to 128 Å, such as from 110 Å to 125 Å, or such as from 115 Å to 122 Å.

Clause 123: The method of clause 120, wherein the second film of the second dielectric layer comprises zinc stannate.

Clause 124: The method of clause 120 or 123, wherein the second film of the second dielectric layer comprises a thickness in a range of from 640 Å to 810 Å, such as from 660 Å to 790 Å, such as from 680 Å to 770 Å, or such as from 685 Å to 715 Å.

Clause 125: The method of clause 120, wherein the third film of the second dielectric layer comprises zinc oxide.

Clause 126: The method of clause 120 or 125, wherein the third film of the second dielectric layer comprises a thickness in a range of from 90 Å to 112 Å, such as from 92 Å to 110 Å, such as from 95 Å to 107 Å, or such as from 98 Å to 103 Å.

Clause 127: The method of any one of clauses 103 to 126, wherein the second dielectric layer comprises a total thickness in a range of from 860 Å to 1028 Å, such as from 885 Å to 1002 Å, or such as from 898 Å to 940 Å.

Clause 128: The method of any one of clauses 103 to 127, wherein the second metallic layer comprises metallic gold, copper, palladium, aluminum, silver, or mixtures, alloys, or combinations thereof.

Clause 129: The method of any one of clauses 103 to 128, wherein the second metallic layer comprises silver.

Clause 130: The method of any one of clauses 103 to 129, wherein the second metallic layer comprises a thickness in a range of from 72 Å to 90 Å, such as from 75 Å to 88 Å, or such as from 79 Å to 84 Å.

Clause 131: The method of any one of clauses 103 to 130, further comprising forming a second primer layer over at least a portion of the second metallic layer.

Clause 132: The method of clause 131, wherein the second primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the second primer layer is deposited as a metal and subsequently oxidized.

Clause 133: The method of clause 131 or 132, wherein the second primer layer comprises aluminum zinc.

Cause 134: The method of any one of clauses 131 to 133, wherein the second primer layer comprises a thickness in a range of from 5 Å to 60 Å, such as from 8 Å to 50 Å, such as from 10 Å to 40 Å, or such as from 15 Å to 35 Å.

Clause 135: The method of any one of clauses 103 to 134, wherein forming the third dielectric layer comprises forming a first film over at least a portion of the second metallic layer and forming a second film over at least a portion of the first film.

Clause 136: The method of clause 135, wherein the first film of the third dielectric layer comprises zinc oxide.

Clause 137: The method of clause 135 or 136, wherein the first film of the third dielectric layer comprises a thickness in a range of from 65 Å to 80 Å, such as from 68 Å to 78 Å, such as from 70 Å to 76 Å, or such as from 71 Å to 74 Å.

Clause 138: The method of clause 135, wherein the second film of the third dielectric layer comprises zinc stannate or tin oxide.

Clause 139: The method of clause 135 or 138, wherein the second film of the third dielectric layer comprises a thickness in a range of from 250 Å to 330 Å, such as from 260 Å to 320 Å, such as from 270 Å to 310 Å, or such as from 275 Å to 280 Å.

Clause 140: The method of any one of clauses 103 to 139, wherein the third dielectric layer comprises a total thickness in a range of from 328 Å to 398 Å, such as from 340 Å to 386 Å, or such as from 346 Å to 354 Å.

Clause 141: The method of any one of clauses 103 to 140, further comprising forming an outermost protective coating over at least a portion of the functional coating, wherein the outermost protective coating comprises at least one protective layer.

Clause 142: The method of clause 141, wherein the at least one protective layer comprises at least one of Si₃N₄, SiON, SiAlN, SiAlON, titania, alumina, silica, or zirconia.

Clause 143: The method of clause 141, wherein the outermost protective coating comprises a first protective layer over at least a portion of the third dielectric layer and a second protective layer over at least a portion of the first protective layer.

Clause 144: The method of clause 143, wherein the first protective layer comprises SiAl and the second protective layer comprises SiO₂.

Clause 145: The method of any one of clauses 141 to 144, wherein the outermost protective coating comprises a thickness in a range of from 495 Å to 610 Å, such as from 515 Å to 590 Å, such as from 525 Å to 580 Å, or such as from 535 Å to 570 Å.

Clause 146: The method of any one of clauses 103 to 145, wherein the laminate comprises a veiling glare, as determined relative to normal of the laminate, of less than or equal to 22%, such as less than or equal to 20%, or such as less than equal to 19%.

Clause 147: The method of any one of clauses 103 to 146, wherein the functional coating is configured to reflect at least 10.0% and no more than 20.0% of p-polarized radiation that contacts the functional coating at the incident angle of 60° relative to normal of the laminate, wherein the functional coating reflects p-polarized radiation at the reflected angle ranging from 40° to 70° relative to normal of the laminate, wherein the reflected p-polarized radiation comprises wavelengths ranging from 646 nm to 654 nm.

Clause 148: The method of any one of clauses 103 to 147, wherein the functional coating is configured to reflect at least 10.0% and no more than 20.0% of p-polarized radiation that contacts the functional coating at the incident angle of 60° relative to normal of the laminate, wherein the functional coating reflects p-polarized radiation at the reflected angle ranging from 40° to 70° relative to normal of the laminate, wherein the reflected p-polarized radiation comprises wavelengths ranging from 515 nm to 525 nm.

Clause 149: The method of any one of clauses 103 to 148, wherein the functional coating is configured to reflect at least 10.0% and no more than 21.5% of p-polarized radiation that contacts the functional coating at the incident angle of 60° relative to normal of the laminate, wherein the functional coating reflects p-polarized radiation at the reflected angle ranging from 40° to 70° relative to normal of the laminate, wherein the reflected p-polarized radiation comprises wavelengths ranging from 445 nm to 465 nm.

Clause 150: The method of any one of clauses 103 to 149, wherein the laminate comprises a visible light transmittance (LTA) of at least 70%.

Clause 151: The method of any one of clauses 103 to 150, wherein the laminate comprises a RgL* value of no more than 55, as determined relative to normal of the laminate.

Clause 152: The method of any one of clauses 103 to 151, wherein the laminate in a windshield.

Clause 153: A vehicle head-up display (HUD) system comprising: a radiation source; and a windshield comprising: a first substrate having a No. 1 surface and a No. 2 surface opposite the No. 1 surface; a second substrate having a No. 3 surface and a No. 4 surface opposite the No. 3 surface; an interlayer positioned between the No. 2 surface and the No. 3 surface; and a functional coating positioned on the No. 3 surface, the functional coating comprising: a first dielectric layer over at least a portion of the No. 3 surface, wherein the first dielectric layer comprises a first film comprising tin oxide over at least a portion of the No. 3 surface and a second film over at least a portion of the first film, and wherein the first dielectric layer comprises a total thickness in a range of from 299 Å to 447 Å; a first metallic layer over at least a portion of the first dielectric layer, wherein the first metallic layer comprises a thickness in a range of from 125 Å to 162 Å; a second dielectric layer over at least a portion of the metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å; wherein the radiation source is configured to emit radiation comprising p-polarized radiation at an incident angle of 60° relative to normal of the windshield; and wherein the functional coating is configured to reflect at least 10.0% of the p-polarized radiation at a reflected angle ranging from 40° to 70° relative to normal of the windshield.

Clause 154: The vehicle HUD system of clause 153, wherein the functional coating is configured to reflect at least 13.5% of p-polarized radiation that contacts the functional coating at the reflected angle ranging from 40° to 70° relative to normal of the windshield.

Clause 155: The vehicle HUD system of clause 153 or 154, wherein the p-polarized radiation comprises wavelengths ranging from 445 nm to 654 nm.

Clause 156: The vehicle HUD system of any one of clauses 153 to 155, wherein the functional coating consists of two metallic layers.

Clause 157: The vehicle HUD system of any one of clauses 153 to 156, wherein the second film of the first dielectric layer comprises zinc oxide.

Clause 158: The vehicle HUD system of any one of clauses 153 to 157, wherein the first film of the first dielectric layer comprises a thickness in a range of from 235 Å to 365 Å, such as from 245 Å to 355 Å, such as from 255 Å to 345 Å, or such as from 258 Å to 265 Å, and wherein the second film of the first dielectric layer comprises a thickness in a range of from 64 Å to 82 Å, such as from 66 Å to 80 Å, such as from 68 Å to 78 Å, or such as from 70 Å to 76 Å.

Clause 159: The vehicle HUD system of any one of clauses 153 to 156, wherein the first dielectric layer further comprises a third film over at least a portion of the second film.

Clause 160: The vehicle HUD system of clause 159, wherein when the first dielectric layer comprises the third film over at least a portion of the second film, the first film comprises tin oxide, the second film comprises zinc stannate, and the third film comprises zinc oxide.

Clause 161: The vehicle HUD system of clause 159 or 160, wherein the first film of the first dielectric layer comprises a thickness in a range of from 145 Å to 195 Å, such as from 150 Å to 190 Å, such as from 157 Å to 180 Å, or such as from 159 Å to 163 Å, wherein the second film of the first dielectric layer comprises a thickness in a range of from 90 Å to 170 Å, such as from 95 Å to 165 Å, such as from 98 Å to 165 Å, or such as from 99 Å to 102 Å, and wherein the third film of the first dielectric layer comprises a thickness in a range of from 64 Å to 82 Å, such as from 66 Å to 80 Å, such as from 68 Å to 78 Å, or such as from 70 Å to 76 Å.

Clause 162: The vehicle HUD system of any one of clauses 153 to 161, wherein the first dielectric layer comprises a total thickness in a range of from 311 Å to 435 Å, such as from 323 Å to 423 Å, or such as from 328 Å to 341 Å.

Clause 163: The vehicle HUD system of any one of clause 153 to 162, wherein the first metallic layer comprises metallic gold, copper, palladium, aluminum, silver, or mixtures, alloys, or combinations thereof.

Clause 164: The vehicle HUD system of any one of clauses 153 to 163, wherein the first metallic layer comprises silver.

Clause 165: The vehicle HUD system of any one of clauses 153 to 164, wherein the first metallic layer comprises a thickness in a range of from 130 Å to 158 Å, such as from 135 Å to 153 Å, or such as from 144 Å to 148 Å.

Clause 166: The vehicle HUD system of any one of clauses 153 to 165, further comprising a first primer layer over at least a portion of the first metallic layer.

Clause 167: The vehicle HUD system of clause 166, wherein the first primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the first primer layer is deposited as a metal and subsequently oxidized.

Clause 168: The vehicle HUD system of clause 166 or 167, wherein the first primer layer comprises aluminum zinc.

Clause 169: The vehicle HUD system of any one of clauses 166 to 168, wherein the first primer layer comprises a thickness in a range of from 5 Å to 60 Å, such as from 8 Å to 50 Å, such as from 10 Å to 40 Å, or such as from 15 Å to 25 Å.

Clause 170: The vehicle HUD system of any one of clauses 153 to 169, wherein the second dielectric layer comprises a first film over at least a portion of the first metallic layer, a second film over at least a portion of the first film, and a third film over at least a portion of the second film.

Clause 171: The vehicle HUD system of clause 170, wherein the first film of the second dielectric layer comprises zinc oxide.

Clause 172: The vehicle HUD system of clause 170 or 171, wherein the first film of the second dielectric layer comprises a thickness in a range of from 105 Å to 130 Å, such as from 108 Å to 128 Å, such as from 110 Å to 125 Å, or such as from 115 Å to 122 Å.

Clause 173: The vehicle HUD system of clause 170, wherein the second film of the second dielectric layer comprises zinc stannate.

Clause 174: The vehicle HUD system of clause 170 or 173, wherein the second film of the second dielectric layer comprises a thickness in a range of from 640 Å to 810 Å, such as from 660 Å to 790 Å, such as from 680 Å to 770 Å, or such as from 685 Å to 715 Å.

Clause 175: The vehicle HUD system of clause 170, wherein the third film of the second dielectric layer comprises zinc oxide.

Clause 176: The vehicle HUD system of clause 170 or 175, wherein the third film of the second dielectric layer comprises a thickness in a range of from 90 Å to 112 Å, such as from 92 Å to 110 Å, such as from 95 Å to 107 Å, or such as from 98 Å to 103 Å.

Clause 177: The vehicle HUD system of any one of clauses 153 to 176, wherein the second dielectric layer comprises a total thickness in a range of from 860 Å to 1028 Å, such as from 885 Å to 1002 Å, or such as from 898 Å to 940 Å.

Clause 178: The vehicle HUD system of any one of clauses 153 to 177, wherein the second metallic layer comprises metallic gold, copper, palladium, aluminum, silver, or mixtures, alloys, or combinations thereof.

Clause 179: The vehicle HUD system of any one of clauses 153 to 178, wherein the second metallic layer comprises silver.

Clause 180: The vehicle HUD system of any one of clauses 153 to 179, wherein the second metallic layer comprises a thickness in a range of from 72 Å to 90 Å, such as from 75 Å to 88 Å, or such as from 79 Å to 84 Å.

Clause 181: The vehicle HUD system of any one of clauses 153 to 180, further comprising a second primer layer over at least a portion of the second metallic layer.

Clause 182: The vehicle HUD system of clause 181, wherein the second primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the second primer layer is deposited as a metal and subsequently oxidized.

Clause 183: The vehicle HUD system of clause 181 or 182, wherein the second primer layer comprises aluminum zinc.

Cause 184: The vehicle HUD system of any one of clauses 181 to 183, wherein the second primer layer comprises a thickness in a range of from 5 Å to 60 Å, such as from 8 Å to 50 Å, such as from 10 Å to 40 Å, or such as from 15 Å to 35 Å.

Clause 185: The vehicle HUD system of any one of clauses 153 to 184, wherein the third dielectric layer comprises a first film over at least a portion of the second metallic layer and a second film over at least a portion of the first film.

Clause 186: The vehicle HUD system of clause 185, wherein the first film of the third dielectric layer comprises zinc oxide.

Clause 187: The vehicle HUD system of clause 185 or 186, wherein the first film of the third dielectric layer comprises a thickness in a range of from 65 Å to 80 Å, such as from 68 Å to 78 Å, such as from 70 Å to 76 Å, or such as from 71 Å to 74 Å.

Clause 188: The vehicle HUD system of clause 185, wherein the second film of the third dielectric layer comprises zinc stannate or tin oxide.

Clause 189: The vehicle HUD system of clause 185 or 188, wherein the second film of the third dielectric layer comprises a thickness in a range of from 250 Å to 330 Å, such as from 260 Å to 320 Å, such as from 270 Å to 310 Å, or such as from 275 Å to 280 Å.

Clause 190: The vehicle HUD system of any one of clauses 153 to 189, wherein the third dielectric layer comprises a total thickness in a range of from 328 Å to 398 Å, such as from 340 Å to 386 Å, or such as from 346 Å to 354 Å.

Clause 191: The vehicle HUD system of any one of clauses 153 to 190, further comprising an outermost protective coating over at least a portion of the functional coating, wherein the outermost protective coating comprises at least one protective layer.

Clause 192: The vehicle HUD system of clause 191, wherein the at least one protective layer comprises at least one of Si₃N₄, SiON, SiAlN, SiAlON, titania, alumina, silica, or zirconia.

Clause 193: The vehicle HUD system of clause 191, wherein the outermost protective coating comprises a first protective layer over at least a portion of the third dielectric layer and a second protective layer over at least a portion of the first protective layer.

Clause 194: The vehicle HUD system of clause 193, wherein the first protective layer comprises SiAl and the second protective layer comprises SiO₂.

Clause 195: The vehicle HUD system of any one of clauses 191 to 194, wherein the outermost protective coating comprises a thickness in a range of from 495 Å to 610 Å, such as from 515 Å to 590 Å, such as from 525 Å to 580 Å, or such as from 535 Å to 570 Å.

Clause 196: The vehicle HUD system of any one of clauses 153 to 195, wherein the windshield comprises a veiling glare, as determined relative to normal of the windshield, of less than or equal to 22%, such as less than or equal to 20%, or such as less than equal to 19%.

Clause 197: The vehicle HUD system of any one of clauses 153 to 196, wherein the functional coating is configured to reflect at least 10.0% and no more than 20.0% of p-polarized radiation that contacts the functional coating at the reflected angle ranging from 40° to 70° relative to normal of the windshield, wherein the reflected p-polarized radiation comprises wavelengths ranging from 646 nm to 654 nm.

Clause 198: The vehicle HUD system of any one of clauses 153 to 197, wherein the functional coating is configured to reflect at least 10.0% and no more than 20.0% of p-polarized radiation that contacts the functional coating at the reflected angle ranging from 40° to 70° relative to normal of the windshield, wherein the reflected p-polarized radiation comprises wavelengths ranging from 515 nm to 525 nm.

Clause 199: The vehicle HUD system of any one of clauses 153 to 198, wherein the functional coating is configured to reflect at least 10.0% and no more than 21.5% of p-polarized radiation that contacts the functional coating at the reflected angle ranging from 40° to 70° relative to normal of the windshield, wherein the reflected p-polarized radiation comprises wavelengths ranging from 445 nm to 465 nm.

Clause 200: The vehicle HUD system of any one of clauses 153 to 199, wherein the windshield comprises a visible light transmittance (LTA) of at least 70%.

Clause 201: The vehicle HUD system of any one of clauses 153 to 200, wherein the windshield comprises a RgL* value of no more than 55, as determined relative to normal of the windshield.

Clause 202: A vehicle comprising a head-up display system, the head-up display system comprising: a radiation source positioned in a front dashboard or a proximate location of the vehicle; and a windshield comprising: a first substrate having a No. 1 surface and a No. 2 surface opposite the No. 1 surface; a second substrate having a No. 3 surface and a No. 4 surface opposite the No. 3 surface; an interlayer positioned between the No. 2 surface and the No. 3 surface; and a functional coating positioned on the No. 3 surface, the functional coating comprising: a first dielectric layer over at least a portion of No. 3 surface, wherein the first dielectric layer comprises a first film comprising tin oxide over at least a portion of the No. 3 surface and a second film over at least a portion of the first film, and wherein the first dielectric layer comprises a total thickness in a range of from 299 Å to 447 Å; a first metallic layer over at least a portion of the first dielectric layer, wherein the first metallic layer comprises a thickness in a range of from 125 Å to 162 Å; a second dielectric layer over at least a portion of the metallic layer, wherein the second dielectric layer comprises a total thickness in a range of from 835 Å to 1052 Å; a second metallic layer over at least a portion of the second dielectric layer, wherein the second metallic layer comprises a thickness in a range of from 70 Å to 95 Å; and a third dielectric layer over at least a portion of the second metallic layer, wherein the third dielectric layer comprises a total thickness in a range of from 315 Å to 410 Å; wherein the radiation source is configured to emit radiation comprising p-polarized radiation at an incident angle of 60° relative to normal of the windshield; wherein the functional coating is configured to reflect at least 10.0% of the p-polarized radiation at a reflected angle ranging from 40° to 70° relative to normal of the laminate; and wherein the radiation emitted from the radiation source is reflected as an image through the No. 4 surface.

Clause 203: The vehicle of clause 202, wherein the functional coating is configured to reflect at least 13.5% of p-polarized radiation that contacts the functional coating at the reflected angle ranging from 40° to 70° relative to normal of the windshield.

Clause 204: The vehicle of clause 202 or 203, wherein the p-polarized radiation comprises wavelengths ranging from 445 nm to 654 nm.

Clause 205: The vehicle of any one of clauses 202 to 204, wherein the functional coating consists of two metallic layers.

Clause 206: The vehicle of any one of clauses 202 to 205, wherein the second film of the first dielectric layer comprises zinc oxide.

Clause 207: The vehicle of any one of clauses 202 to 206, wherein the first film of the first dielectric layer comprises a thickness in a range of from 235 Å to 365 Å, such as from 245 Å to 355 Å, such as from 255 Å to 345 Å, or such as from 258 Å to 265 Å, and wherein the second film of the first dielectric layer comprises a thickness in a range of from 64 Å to 82 Å, such as from 66 Å to 80 Å, such as from 68 Å to 78 Å, or such as from 70 Å to 76 Å.

Clause 208: The vehicle of any one of clauses 202 to 205, wherein the first dielectric layer further comprises a third film over at least a portion of the second film.

Clause 209: The vehicle of clause 208, wherein when the first dielectric layer comprises the third film over at least a portion of the second film, the first film comprises tin oxide, the second film comprises zinc stannate, and the third film comprises zinc oxide.

Clause 210: The vehicle of clause 208 or 209, wherein the first film of the first dielectric layer comprises a thickness in a range of from 145 Å to 195 Å, such as from 150 Å to 190 Å, such as from 157 Å to 180 Å, or such as from 159 Å to 163 Å, wherein the second film of the first dielectric layer comprises a thickness in a range of from 90 Å to 170 Å, such as from 95 Å to 165 Å, such as from 98 Å to 165 Å, or such as from 99 Å to 102 Å, and wherein the third film of the first dielectric layer comprises a thickness in a range of from 64 Å to 82 Å, such as from 66 Å to 80 Å, such as from 68 Å to 78 Å, or such as from 70 Å to 76 Å.

Clause 211: The vehicle of any one of clauses 202 to 210, wherein the first dielectric layer comprises a total thickness in a range of from 311 Å to 435 Å, such as from 323 Å to 423 Å, or such as from 328 Å to 341 Å.

Clause 212: The vehicle of any one of clause 202 to 211, wherein the first metallic layer comprises metallic gold, copper, palladium, aluminum, silver, or mixtures, alloys, or combinations thereof.

Clause 213: The vehicle of any one of clauses 202 to 212, wherein the first metallic layer comprises silver.

Clause 214: The vehicle of any one of clauses 202 to 213, wherein the first metallic layer comprises a thickness in a range of from 130 Å to 158 Å, such as from 135 Å to 153 Å, or such as from 144 Å to 148 Å.

Clause 215: The vehicle of any one of clauses 202 to 214, further comprising a first primer layer over at least a portion of the first metallic layer.

Clause 216: The vehicle of clause 215, wherein the first primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the first primer layer is deposited as a metal and subsequently oxidized.

Clause 217: The vehicle of clause 215 or 216, wherein the first primer layer comprises aluminum zinc.

Clause 218: The vehicle of any one of clauses 215 to 217, wherein the first primer layer comprises a thickness in a range of from 5 Å to 60 Å, such as from 8 Å to 50 Å, such as from 10 Å to 40 Å, or such as from 15 Å to 25 Å.

Clause 219: The vehicle of any one of clauses 202 to 218, wherein the second dielectric layer comprises a first film over at least a portion of the first metallic layer, a second film over at least a portion of the first film, and a third film over at least a portion of the second film.

Clause 220: The vehicle of clause 219, wherein the first film of the second dielectric layer comprises zinc oxide.

Clause 221: The vehicle of clause 219 or 220, wherein the first film of the second dielectric layer comprises a thickness in a range of from 105 Å to 130 Å, such as from 108 Å to 128 Å, such as from 110 Å to 125 Å, or such as from 115 Å to 122 Å.

Clause 222: The vehicle of clause 219, wherein the second film of the second dielectric layer comprises zinc stannate.

Clause 223: The vehicle of clause 219 or 222, wherein the second film of the second dielectric layer comprises a thickness in a range of from 640 Å to 810 Å, such as from 660 Å to 790 Å, such as from 680 Å to 770 Å, or such as from 685 Å to 715 Å.

Clause 224: The vehicle of clause 219, wherein the third film of the second dielectric layer comprises zinc oxide.

Clause 225: The vehicle of clause 219 or 224, wherein the third film of the second dielectric layer comprises a thickness in a range of from 90 Å to 112 Å, such as from 92 Å to 110 Å, such as from 95 Å to 107 Å, or such as from 98 Å to 103 Å.

Clause 226: The vehicle of any one of clauses 202 to 225, wherein the second dielectric layer comprises a total thickness in a range of from 860 Å to 1028 Å, such as from 885 Å to 1002 Å, or such as from 898 Å to 940 Å.

Clause 227: The vehicle of any one of clauses 202 to 226, wherein the second metallic layer comprises metallic gold, copper, palladium, aluminum, silver, or mixtures, alloys, or combinations thereof.

Clause 228: The vehicle of any one of clauses 202 to 227, wherein the second metallic layer comprises silver.

Clause 229: The vehicle of any one of clauses 202 to 228, wherein the second metallic layer comprises a thickness in a range of from 72 Å to 90 Å, such as from 75 Å to 88 Å, or such as from 79 Å to 84 Å.

Clause 230: The vehicle of any one of clauses 202 to 229, further comprising a second primer layer over at least a portion of the second metallic layer.

Clause 231: The vehicle of clause 230, wherein the second primer layer is selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, and wherein the second primer layer is deposited as a metal and subsequently oxidized.

Clause 232: The vehicle of clause 230 or 231, wherein the second primer layer comprises aluminum zinc.

Cause 233: The vehicle of any one of clauses 230 to 232, wherein the second primer layer comprises a thickness in a range of from 5 Å to 60 Å, such as from 8 Å to 50 Å, such as from 10 Å to 40 Å, or such as from 15 Å to 35 Å.

Clause 234: The vehicle of any one of clauses 153 to 184, wherein the third dielectric layer comprises a first film over at least a portion of the second metallic layer and a second film over at least a portion of the first film.

Clause 235: The vehicle of clause 234, wherein the first film of the third dielectric layer comprises zinc oxide.

Clause 236: The vehicle of clause 234 or 235, wherein the first film of the third dielectric layer comprises a thickness in a range of from 65 Å to 80 Å, such as from 68 Å to 78 Å, such as from 70 Å to 76 Å, or such as from 71 Å to 74 Å.

Clause 237: The vehicle of clause 234, wherein the second film of the third dielectric layer comprises zinc stannate or tin oxide.

Clause 238: The vehicle of clause 234 or 237, wherein the second film of the third dielectric layer comprises a thickness in a range of from 250 Å to 330 Å, such as from 260 Å to 320 Å, such as from 270 Å to 310 Å, or such as from 275 Å to 280 Å.

Clause 239: The vehicle of any one of clauses 202 to 238, wherein the third dielectric layer comprises a total thickness in a range of from 328 Å to 398 Å, such as from 340 Å to 386 Å, or such as from 346 Å to 354 Å.

Clause 240: The vehicle of any one of clauses 202 to 239, further comprising an outermost protective coating over at least a portion of the functional coating, wherein the outermost protective coating comprises at least one protective layer.

Clause 241: The vehicle of clause 240, wherein the at least one protective layer comprises at least one of Si₃N₄, SiON, SiAlN, SiAlON, titania, alumina, silica, or zirconia.

Clause 242: The vehicle of clause 240, wherein the outermost protective coating comprises a first protective layer over at least a portion of the third dielectric layer and a second protective layer over at least a portion of the first protective layer.

Clause 243: The vehicle of clause 242, wherein the first protective layer comprises SiAl and the second protective layer comprises SiO₂.

Clause 244: The vehicle of any one of clauses 240 to 243, wherein the outermost protective coating comprises a thickness in a range of from 495 Å to 610 Å, such as from 515 Å to 590 Å, such as from 525 Å to 580 Å, or such as from 535 Å to 570 Å.

Clause 245: The vehicle of any one of clauses 202 to 244, wherein the windshield comprises a veiling glare, as determined relative to normal of the windshield, of less than or equal to 22%, such as less than or equal to 20%, or such as less than equal to 19%.

Clause 246: The vehicle of any one of clauses 202 to 245, wherein the functional coating is configured to reflect at least 10.0% and no more than 20.0% of p-polarized radiation that contacts the functional coating at the reflected angle ranging from 40° to 70° relative to normal of the windshield, wherein the reflected p-polarized radiation comprises wavelengths ranging from 646 nm to 654 nm.

Clause 247: The vehicle of any one of clauses 202 to 246, wherein the functional coating is configured to reflect at least 10.0% and no more than 20.0% of p-polarized radiation that contacts the functional coating at the reflected angle ranging from 40° to 70° relative to normal of the windshield, wherein the reflected p-polarized radiation comprises wavelengths ranging from 515 nm to 525 nm.

Clause 248: The vehicle of any one of clauses 202 to 247, wherein the functional coating is configured to reflect at least 10.0% and no more than 21.5% of p-polarized radiation that contacts the functional coating at the reflected angle ranging from 40° to 70° relative to normal of the windshield, wherein the reflected p-polarized radiation comprises wavelengths ranging from 445 nm to 465 nm.

Clause 249: The vehicle of any one of clauses 202 to 248, wherein the windshield comprises a visible light transmittance (LTA) of at least 70%.

Clause 250: The vehicle of any one of clauses 202 to 249, wherein the windshield comprises a RgL* value of no more than 55, as determined relative to normal of the windshield.

### BRIEF DESCRIPTION OF THE DRAWINGS

The disclosure will be described with reference to the following drawing figures wherein like reference numbers identify like parts throughout.

FIG. 1 is a side view (not to scale) of a coated article according to the present invention;

FIG. 2 is a side view (not to scale) of a coated article according to the present invention;

FIG. 3 is a side view (not to scale) of a coated article according to the present invention;

FIG. 4 is a side view (not to scale) of a coated article contacted with p-polarized radiation according to the present invention;

FIG. 5 is side view (not to scale) image depicting veiling glare of the prior art;

FIGS. 6A and 6B are side views (not to scale) of coated articles according to the present invention;

FIGS. 7A and 7B are side views (not to scale) of laminates according to the present invention;

FIG. 8 is a side view (not to scale) of a head-up display system;

FIG. 9 is a side view (not to scale) of a vehicle head-up display system; and

FIG. 10 is a graph depicting reflected p-polarized for examples according to the present invention.

### DESCRIPTION OF THE INVENTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like.

“A” or “an” refers to one or more.

Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate.

As used herein, the terms “polymer” or “polymeric” include oligomers, homopolymers, copolymers, and terpolymers, e.g., polymers formed from two or more types of monomers or polymers.

The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm.

Additionally, all documents, such as, but not limited to, issued patents and patent applications, referred to herein are to be considered to be “incorporated by reference” in their entirety.

As used herein, the term “film” refers to a coating region of a desired or selected coating composition. A “layer” can comprise one or more “films”, and a “coating” or “coating stack” can comprise one or more “layers”. The terms “metal” and “metal oxide” include silicon and silica, respectively, as well as traditionally recognized metals and metal oxides, even though silicon conventionally may not be considered a metal. Thickness values, unless indicated to the contrary, are geometric thickness values.

The discussion of the invention may describe certain features as being “particularly” or “preferably” within certain limitations (e.g., “preferably”, “more preferably”, or “most preferably”, within certain limitations). It is to be understood that the invention is not limited to these particular or preferred limitations but encompasses the entire scope of the disclosure.

Weight percentages (wt. %) of the metal oxides, metal alloys, metal nitrides, or metal oxynitrides, as used herein, are based on the total weight of the metal components and exclude the weight of any oxide, nitride, or oxynitride components.

The invention is directed to a coated article. The coated article comprises a first substrate having a No. 1 surface and a No. 2 surface opposite the No. 2 surface and a functional coating positioned over at least a portion of the No. 2 surface. The functional coating comprises a first dielectric layer over at least a portion of the No. 2 surface, wherein the first dielectric layer comprises a first film comprising tin oxide and a second film over at least a portion of the first film, and wherein the first dielectric layer 32 comprises a total thickness in a range of from 299 Å to 447 Å. The functional coating further comprises a first metallic layer over at least a portion of the first dielectric layer, wherein the first metallic layer comprises a thickness in a range of from 125 Å to 162 Å. The functional coating further comprises a second dielectric layer over at least a portion of the first metallic layer, wherein the second dielectric layer comprises a total thickness in a range of from 835 Å to 1052 Å. The functional coating further comprises a second metallic layer over at least a portion of the second dielectric layer, wherein the second metallic layer comprises a thickness in a range of from 70 Å to 95 Å. The functional coating further comprises a third dielectric layer over at least a portion of the second metallic layer, wherein the third dielectric layer comprises a total thickness in a range of from 315 Å to 410 Å. The functional coating is configured to reflect at least 10% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

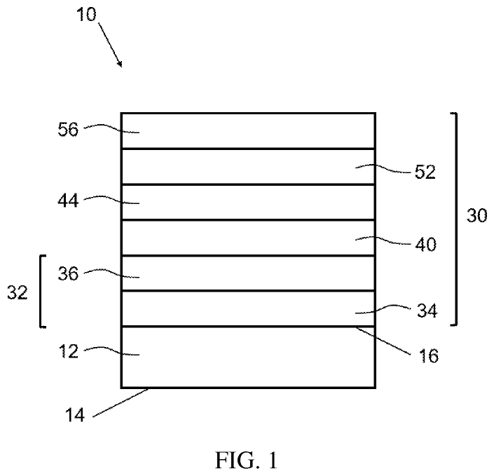

Referring to FIG. 1, the coated article 10 comprises a first substrate 12. The first substrate 12 can be of any desired material having any desired characteristics, such as opaque, translucent, or transparent to visible light. For example, the first substrate 12 can be transparent or translucent to visible light. By “transparent” is meant having visible light transmission of greater than 0% up to 100%. Alternatively, the first substrate 12 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the first substrate 12 can be conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155, which are incorporated by reference herein. The first substrate 12 may comprise, for example, clear float glass or can be tinted or colored glass.

The first substrate 12 can be of any desired dimensions, e.g., length, width, shape, or thickness. However, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

In some embodiments, the first substrate 12 can be a monolithic glazing. By “monolithic” is meant having a single structural support or structural member, e.g., having a single substrate.

The first substrate 12 comprises a No. 1 surface 14 and a No. 2 surface 16. The No. 2 surface 16 is opposite the No. 1 surface 14.

The functional coatings 30 described herein can be deposited by any useful method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as, magnetron sputter vapor deposition (MSVD)). Other coating methods could also be used, such as, but not limited to, sol-gel deposition, slot die coating deposition, or printing depositions, such as, screen printing or ink jet printing. In one non-limiting embodiment, the functional coating 20 is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750, all of which are incorporated by reference herein.

The functional coating 30 is positioned over at least a portion of the No. 2 surface 16 of the first substrate 12. The functional coating 30 is a double metal coating consisting of two metallic layers. Exemplary functional coatings 30 are shown in FIGS. 1-3.

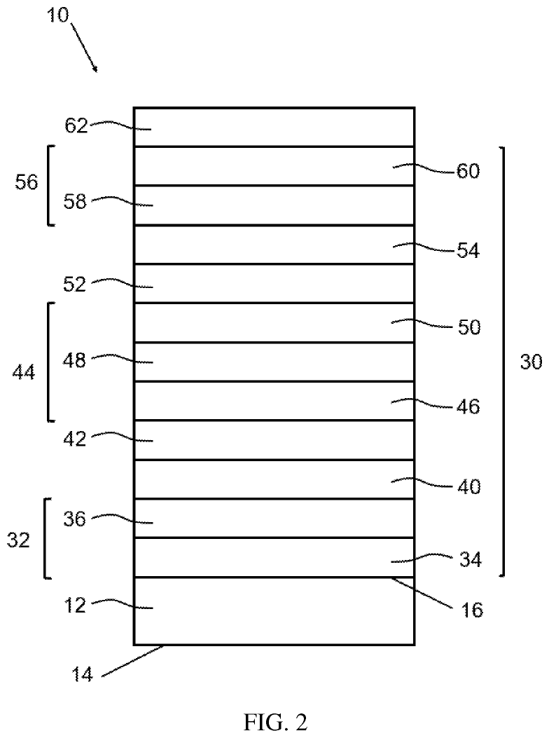

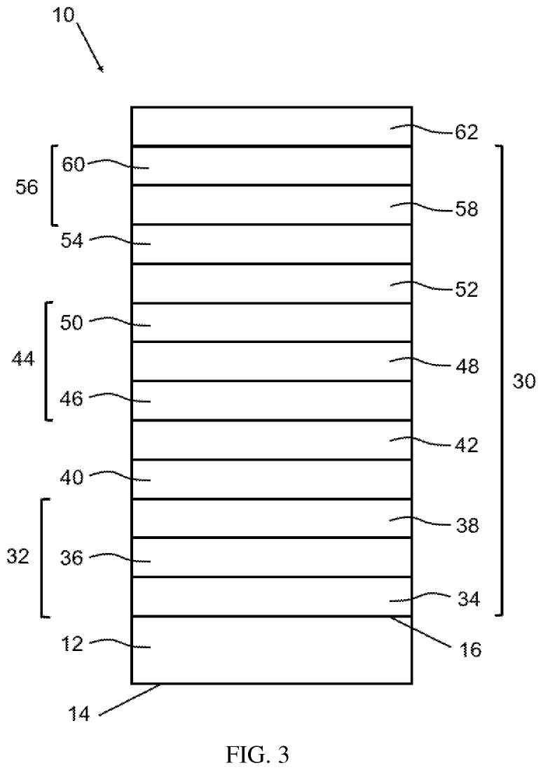

The functional coating 30 comprises a first dielectric layer 32 over or in direct contact with the No. 2 surface 16 of the first substrate 12. The first dielectric layer 32 may be positioned over or in direct contact with a portion or the entire No. 2 surface 16 of the first substrate 12. The first dielectric layer 32 comprises a first film 34 comprising tin oxide over or in direct contact with the No. 2 surface 16 of the first substrate 12 and a second film 36 over or in direct contact with the first film 34. The functional coating 30 comprises a first metallic layer 40 over or in direct contact with at least a portion of the first dielectric layer 32. The functional coating 30 comprises an optional first primer layer 42 (see e.g., FIGS. 2 and 3) over or in direct contact with at least a portion of the first metallic layer 40. The functional coating 30 comprises a second dielectric layer 44 over or in direct contact with at least a portion of the first metallic layer 40 or optional first primer layer 42. The functional coating 30 comprises a second metallic layer 52 over or in direct contact with at least a portion of the second dielectric layer 44. The functional coating 30 comprises an optional second primer layer 54 (see e.g., FIGS. 2 and 3) over or in direct contact with at least a portion of the second metallic layer 52. The functional coating 30 comprises a third dielectric layer 56 over or in direct contact with at least a portion of the second metallic layer 52 or optional second primer layer 54. An optional outermost protective coating 62 (see e.g., FIGS. 2 and 3) comprising a protective layer may be over or in direct contact with at least a portion of the functional coating 30, such as over or in direct contact with at least a portion of the third dielectric layer 56 of the functional coating 30.

As shown in FIGS. 1-3, the functional coating 30 comprises a first dielectric layer 32 positioned over or in direct contact with the No. 2 surface 16 of the first substrate 12. The first dielectric layer 32 may be positioned over or in direct contact with a portion or the entire No. 2 surface 16 of the first substrate 12. The first dielectric layer 32 comprises a first film 34 positioned over or in direct contact with the No. 2 surface 16 of the first substrate 12, a second film 36 positioned over or in direct contact with the first film 34, and optionally a third film 38 positioned over or in direct contact with the second film 36. The first dielectric layer 32 can be transparent to visible light.

The first film 34, the second film 36, and the optional third film 38 of the first dielectric layer 32 can comprise antireflective materials and/or dielectric materials, such as, but not limited to, metal oxides, oxides of metal alloys, nitrides, oxynitrides, or mixtures thereof. The metal oxides, metal nitrides, and/or metal oxynitrides may be metal oxides, metal nitrides, and/or metal oxynitrides of titanium, hafnium, zirconium, niobium, zinc, bismuth, lead, indium, tin, aluminum, silicon and mixtures thereof. These metal oxides can have small amounts of other materials, such as, manganese in bismuth oxide, tin in indium oxide, etc. Additionally, oxides of metal alloys or metal mixtures can be used, such as, oxides containing zinc and tin (e.g., zinc stannate, defined below), oxides of indium-tin alloys, oxides containing zinc and aluminum, silicon nitrides, silicon aluminum nitrides, or aluminum nitrides. Further, doped metal oxides, such as, antimony or indium doped tin oxides or nickel or boron doped silicon oxides, can be used.

In certain non-limiting embodiments or aspects, the first film 34 of the first dielectric layer 32 comprises tin oxide. The tin oxide can be obtained from magnetron sputtering vacuum deposition from a target of tin or a target of tin and zinc. For example, the tin target can include a small amount (e.g., up to 20 wt. %, up to 15 wt. %, up to 10 wt. %, or up to 5 wt. %) of zinc. In which case, the resultant tin oxide film would include a small percentage of zinc oxide, e.g., up to 20 wt. % zinc oxide, e.g., up to 10 wt. % zinc oxide, e.g., up to 5 wt. % zinc oxide. A film deposited from a tin target having up to from 0 wt. % to 20 wt. % zinc is referred to herein as “a tin oxide film”. The first film 34 of the first dielectric layer 32 may be a tin oxide film where tin is substantially the only metal in the first film 34. As used herein, “substantially free” means that the tin oxide film contains less than 0.5 wt. % of additional metals other than tin. The tin oxide film 32 may include 80 wt. % tin oxide and 20 wt. % zinc oxide. The tin oxide film 32 may include 90% tin oxide and 10 wt. % zinc oxide.

The second film 36 of the first dielectric layer 32 can comprise a zinc/tin alloy oxide. By “zinc/tin alloy oxide” is meant both true alloys, and mixtures of the oxides. The zinc target can include a small amount (e.g., up to 20 wt. %, up to 15 wt. %, up to 10 wt. %, or up to 5 wt. %) of tin to improve sputtering. In which case, the resultant zinc oxide film would include a small percentage of tin oxide, e.g., up to 20 wt. %, up to 15 wt. %, up to 10 wt. % tin oxide, or up to 5 wt. % tin oxide, wherein the remainder of the target is zinc. A coating layer deposited from a zinc target having up to 20 wt. % tin (or less) (added to enhance the conductivity of the target) is referred to herein as “a zinc oxide film” even though a small amount of tin may be present.

The second film 36 of the first dielectric layer 32 can comprise a metal alloy oxide, e.g., a zinc stannate film over at least a portion of the first film 34. By “zinc stannate” is meant a composition of ZnₓSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=⅔, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the layer.

The first dielectric layer 32 may optionally comprise a third film 38 over or in direct contact with at least a portion of the second film 36 (FIG. 3). When present, the third film 38 can comprise zinc oxide.

When the first dielectric layer 32 comprises the first film 34 and the second film 36, the first film 34 comprises tin oxide and the second film 36 may comprise zinc oxide.

When the first dielectric layer 32 comprises the first film 34 and the second film 36, the first film 34 comprises a thickness in a range of from 235 Å to 365 Å, such as from 245 Å to 355 Å, such as from 255 Å to 345 Å, or such as from 258 Å to 265 Å.

When the first dielectric layer 32 comprises the first film 34 and the second film 36, the second film 36 comprises a thickness in a range of from 64 Å to 82 Å, such as from 66 Å to 80 Å, such as from 68 Å to 78 Å, or such as from 70 Å to 76 Å.

When the first dielectric layer 32 comprises the first film 34, the second film 36, and the third film 38, the first film 34 comprises tin oxide, the second film 36 may comprise zinc stannate, and the third film 38 may comprise zinc oxide.

When the first dielectric layer 32 comprises the first film 34, the second film 36, and the third film 38, the first film 34 comprises a thickness in a range of from 145 Å to 195 Å, such as from 150 Å to 190 Å, such as from 157 Å to 180 Å, or such as from 159 Å to 163 Å.

When the first dielectric layer 32 comprises the first film 34, the second film 36, and the third film 38, the second film 36 comprises a thickness in a range of from 90 Å to 170 Å, such as from 95 Å to 165 Å, such as from 98 Å to 165 Å, or such as from 99 Å to 102 Å.

When the first dielectric layer 32 comprises the first film 34, the second film 36, and the third film 38, the third film 38 comprises a thickness in a range of from 64 Å to 82 Å, such as from 66 Å to 80 Å, such as from 68 Å to 78 Å, or such as from 70 Å to 76 Å.

The first dielectric layer 32 may comprise a total thickness (e.g., the combined thickness of the first film 34, the second film 36, and the third film 38 (when present)) in a range of from 299 Å to 447 Å, such as from 311 Å to 435 Å, such as from 323 Å to 423 Å, or such as from 328 Å to 341 Å.

The functional coating 30 comprises a first metallic layer 40 positioned over or in direct contact with a portion of or the entire first dielectric layer 32, such as over or in direct contact with at least a portion of or the entire second film 36 of the first dielectric layer 32 or optional third film 38 of the first dielectric layer 32.

The first metallic layer 40 can include a reflective metal, such as, but not limited to, metallic gold, copper, palladium, aluminum, silver, or mixtures, alloys, or combinations thereof. For example, the first metallic layer 40 comprises a metallic silver layer. The first metallic layer 40 is a continuous layer. By “continuous layer” is meant that the coating has a thickness above the percolation threshold.

The first metallic layer 40 can comprise a thickness in a range of from 125 Å to 162 Å, such as 130 Å to 158 Å, such as from 135 Å to 153 Å, or such as from 144 Å to 148 Å.

As indicated, the functional coating 30 may optionally comprise a first primer layer 42 positioned over or in direct contact with at least a portion of or the entire the first metallic layer 40. The first primer layer 42 can be a single film or a multiple film layer. The first primer layer 42, when present, can include an oxygen-capturing material that can be sacrificial during the deposition process to prevent degradation or oxidation of the first metallic layer 40 during the sputtering process or subsequent heating process. The first primer layer 42, when present, can also absorb at least a portion of electromagnetic radiation, such as visible light, passing through the functional coating 30. Examples of materials useful for the first primer layer 42, when present, includes zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof. For example, the first primer layer 42, when present, may comprise titanium, titanium and aluminum, zinc and aluminum, nickel chrome (e.g., Inconel®), or cobalt chrome (e.g., Stellite®), which is deposited as a metal and at least a portion of the first primer layer 42 is subsequently oxidized.

The first primer layer 42, when present, can comprise a thickness in a range of from 5 Å to 60 Å, such as from 8 Å to 50 Å, such as from 10 Å to 40 Å, or such as from 15 Å to 25 Å.

The functional coating 30 comprises a second dielectric layer 44 positioned over or in direct contact with at least a portion of the first metallic layer 40 or the optional first primer layer 42. The second dielectric layer 44 comprises a first film 46 positioned over or in direct contact with at least a portion of the first metallic layer 40 or the optional first primer layer 42, a second film 48 positioned over or in direct contact with at least a portion of the first film 44, and a third film 50 positioned over or in direct contact with at least a portion of the second film 48.

The first film 46, the second film 48, and the third film 50 of the second dielectric layer 44 can comprise one or more metal oxide, metal alloy oxide, metal nitride, metal alloy nitride, metal oxynitride, or metal alloy oxynitride-containing films, such as those described above with respect to the first film 32, the second film 34, and the optional third film 38 of the first dielectric layer 32. For example, the first film 46 of the second dielectric layer 44 can comprise a metal oxide, e.g., a zinc oxide, deposited over at least a portion of the first metallic layer 40 or the optional first primer layer 42. For example, the second film 48 of the second dielectric layer 44 can comprise a metal alloy oxide, e.g., a zinc stannate film over at least a portion of the first film 46. For example, the third film 50 of the second dielectric layer 44 can comprise a metal oxide, e.g., a zinc oxide, deposited over at least a portion of the second film 48.

The first film 46 of the second dielectric layer 44 can comprise a thickness in a range of from 105 Å to 130 Å, such as from 108 Å to 128 Å, such as from 110 Å to 125 Å, or such as from 115 Å to 122 Å.

The second film 48 of the second dielectric layer 46 can comprise a thickness in a range of from 640 Å to 810 Å, such as from 660 Å to 790 Å, such as from 680 Å to 770 Å, or such as from 685 Å to 715 Å.

The third film 50 of the second dielectric layer 44 can comprise a thickness in a range of from 90 Å to 112 Å, such as from 92 Å to 110 Å, such as from 95 Å to 107 Å, or such as from 98 Å to 103 Å.

The second dielectric layer 44 can comprise a total thickness (e.g., the combined thicknesses of the first film 46, the second film 48, and the third film 50) in a range of from 835 Å to 1052 Å, such as from 860 Å to 1028 Å, such as from 885 Å to 1002 Å, or such as from 898 Å to 940 Å.

The functional coating 30 comprises a second metallic layer 52 positioned over or in direct contact with at least a portion of the second dielectric layer 44, such as over or in direct contact with at least a portion of the third film 50 of the second dielectric layer 44.

The second metallic layer 52 can include a reflective metal, such as, but not limited to, metallic gold, copper, palladium, aluminum, silver, or mixtures, alloys, or combinations thereof. For example, the second metallic layer 52 comprises a metallic silver layer. The second metallic layer 52 is a continuous layer.

The second metallic layer 52 can comprise a thickness in a range of from 70 Å to 95 Å, such as from 72 Å to 90 Å, such as from 75 Å to 88 Å, or such as from 79 Å to 84 Å.

As previously noted, the functional coating 30 may optionally comprise a second primer layer 54 positioned over or in direct contact with at least a portion of the second metallic layer 52. The second primer layer 54 can be a single film or a multiple film layer. The second primer layer 54, when present, can include an oxygen-capturing material that can be sacrificial during the deposition process to prevent degradation or oxidation of the second metallic layer 52 during the sputtering process or subsequent heating process. Examples of materials useful for the second primer layer 54 are the same as those described with respect to the first primer layer 42. For example, the second primer layer 54 may comprise titanium, titanium and aluminum, zinc and aluminum, nickel chrome (e.g., Inconel®), or cobalt chrome (e.g., Stellite®), which is deposited as a metal and at least a portion of the second primer layer 54 is subsequently oxidized.

The second primer layer 54, when present, can comprise a thickness in a range of from 5 Å to 60 Å, such as from 8 Å to 50 Å, such as from 10 Å to 40 Å, or such as from 15 Å to 35 Å.

The functional coating 30 comprises a third dielectric layer 56 positioned over or in direct contact with at least a portion of the second metallic layer 52 or the optional second primer layer 54. The third dielectric layer 56 can comprise a first film 58 positioned over or in direct contact with at least a portion of the second metallic layer 52 or the optional second primer layer 54 and a second film 60 positioned over or in direct contact with at least a portion of the first film 58.

The first film 58 and the second film 60 of the third dielectric layer 56 can comprise one or more metal oxide, metal alloy oxide, metal nitride, metal alloy nitride, metal oxynitride, or metal alloy oxynitride-containing films, such as those described above with respect to the first film 32, the second film 34, and the optional third film 38 of the first dielectric layer 32. For example, the first film 58 of the third dielectric layer 56 can comprise a metal oxide, e.g., a zinc oxide, deposited over at least a portion of the second metallic layer 52 or the optional second primer layer 54. For example, the second film 60 of the third dielectric layer 56 can comprise a metal alloy oxide, e.g., a zinc stannate film or a tin oxide film over at least a portion of the first film 58.

In some non-limiting embodiments, the second film 60 of the third dielectric layer 56 is the uppermost layer of the functional coating 30.

The first film 58 of the third dielectric layer 56 can comprise a thickness in a range of from 65 Å to 80 Å, such as from 68 Å to 78 Å, such as from 70 Å to 76 Å, or such as from 71 Å to 74 Å.

The second film 60 of the third dielectric layer 56 can comprise a thickness in a range of from 250 Å to 330 Å, such as from 260 Å to 320 Å, such as from 270 Å to 310 Å, or such as from 275 Å to 280 Å.

The third dielectric layer 56 can comprise a total thickness (e.g., the combined thicknesses of the first film 58 and the second film 60) in a range of from 315 Å to 410 Å, such as from 328 Å to 398 Å, such as from 340 Å to 386 Å, or such as from 346 Å to 354 Å.

An outermost protective coating 62 may optionally be positioned over or in direct contact with at least a portion of the outermost layer of the functional coating 30, such as over or in direct contact with at least a portion of the second film 60 of the third dielectric layer 56. The outermost protective coating 62, when present, can help protect the underlying layers of the functional coating 30 from mechanical and/or chemical attack. The outermost protective coating 62, when present, can be an oxygen barrier coating layer to prevent or reduce the passage of ambient oxygen into the underlying layers of the functional coating 30, such as, during heating or bending. The outermost protective coating 62, when present, can be of any desired material or mixture of materials. The outermost protective coating 62 comprises at least one protective layer, wherein the protective layer comprises at least one of Si₃N₄, SiAlN, SiAlON, SiAlO, TiAlO, titania (TiO₂), alumina (Al₂O₃), silica (SiO₂), zirconia (ZrO₂), or combinations thereof.

The outermost protective coating 62, when present, may comprise a single protective film. The single protective film may comprise titania.

The outermost protective coating 62, when present, may comprise a multi-layer structure. For example, the outermost protective coating 62, when present, may comprise a first protective layer 64 positioned over or in direct contact with at least a portion of the uppermost layer of the functional coating 30, such the second film 60 of the third dielectric layer 56, and a second protective layer 66 may be positioned over or in direct contact with at least a portion of the first protective layer 64.

For example, the first protective layer 64 can comprise alumina or a mixture or alloy comprising alumina and silica. For example, the first protective layer 64 can comprise a silica/alumina mixture having greater than 5 wt. % alumina, such as greater than 10 wt. % alumina, such as greater than 15 wt. % alumina, such as greater than 30 wt. % alumina, such as greater than 40 wt. % alumina, such as 50 wt. % to 70 wt. % alumina, such as in the range of 70 wt. % to 100 wt. % alumina and 30 wt. % to 0 wt. % silica, such as greater than 90 wt. % alumina, such as greater than 95 wt. % alumina. Alternatively, the first protective layer 64 may comprise all or substantially all alumina. The second protective layer 66 can comprise silica or a mixture or alloy comprising silica and alumina. For example, the second protective layer 66 can comprise a silica/alumina mixture having greater than 40 wt. % silica, such as greater than 50 wt. % silica, such as greater than 60 wt. % silica, such as greater than 70 wt. % silica, such as greater than 80 wt. % silica, such as in the range of 80 wt. % to 90 wt. % silica and 10 wt. % to 20 wt. % alumina, e.g., 85 wt. % silica and 15 wt. % alumina. Alternatively, the second protective layer 66 can comprise all or substantially all silica.

The outermost protective coating 62, when present, may comprise a thickness (e.g., a combined total thickness of the first protective layer 64 and the second protective layer 66 in a range of from 495 Å to 610 Å, such as from 515 Å to 590 Å, such as from 525 Å to 580 Å, or such as from 535 Å to 570 Å.

The functional coating 30 described herein can also be a functional coating 30 according to the following table.

| Layer | Exemplary Material | Thickness |
|---|---|---|
| First Dielectric Layer | First Film: tin oxide | 299 Å to 447 Å; |
| | Second Film: zinc oxide or | preferably 311 Å to 435 Å |
| | First Film: tin oxide | more preferably 323 Å to 423 Å; |
| | Second Film: zinc stannate | most preferably 328 Å to 341 Å |
| | Third Film: zinc oxide | |
| First Metallic Layer | Au, Cu, Pd, Al, and/or Ag | 125 Å to 162 Å; |
| | | preferably 130 Å to 158 Å; |
| | | more preferably 135 Å to 153 Å; |
| | | most preferably 144 Å to 148 Å |
| First Primer Layer | Ti, TiAl, NiCr, CoCr, AlZn | 5 Å to 60 Å; |
| (Optional) | | preferably 8 Å to 50 Å; |
| | | more preferably 10 Å to 40 Å; |
| | | most preferably 15 Å to 25 Å |
| Second Dielectric Layer | First Film: zinc oxide | 835 Å to 1052 Å; |
| | Second Film: zinc stannate | preferably 860 Å to 1028 Å; |
| | Third Film: zinc oxide | more preferably 885 Å to 1002 Å; |
| | | most preferably 898 Å to 940 Å |
| Second Metallic Layer | Au, Cu, Pd, Al, and/or Ag | 70 Å to 95 Å |
| | | preferably 72 Å to 90 Å; |
| | | more preferably 75 Å to 88 Å; |
| | | most preferably 79 Å to 84 Å |
| Second Primer Layer | Ti, TiAl, NiCr, CoCr, AlZn | 5 Å to 60 Å; |
| (Optional) | | preferably 8 Å to 50 Å; |
| | | more preferably 10 Å to 40 Å; |
| | | most preferably 15 Å to 35 Å |
| Third Dielectric Layer | First Film: zinc oxide | 315 Å to 410 Å; |
| | Second Film: zinc stannate | preferably 328 Å to 398 Å; |
| | or tin oxide | more preferably 340 Å to 386 Å; |
| | | most preferably 346 Å to 354 Å |
| Outermost Protective | First Protective Layer: SiAl | 495 Å to 610 Å; |
| Layer (Optional) | Second Protective Layer: SiO₂ | preferably 515 Å to 590 Å; |
| | | more preferably 525 Å to 580 Å; |
| | | most preferably 535 Å to 570 Å |

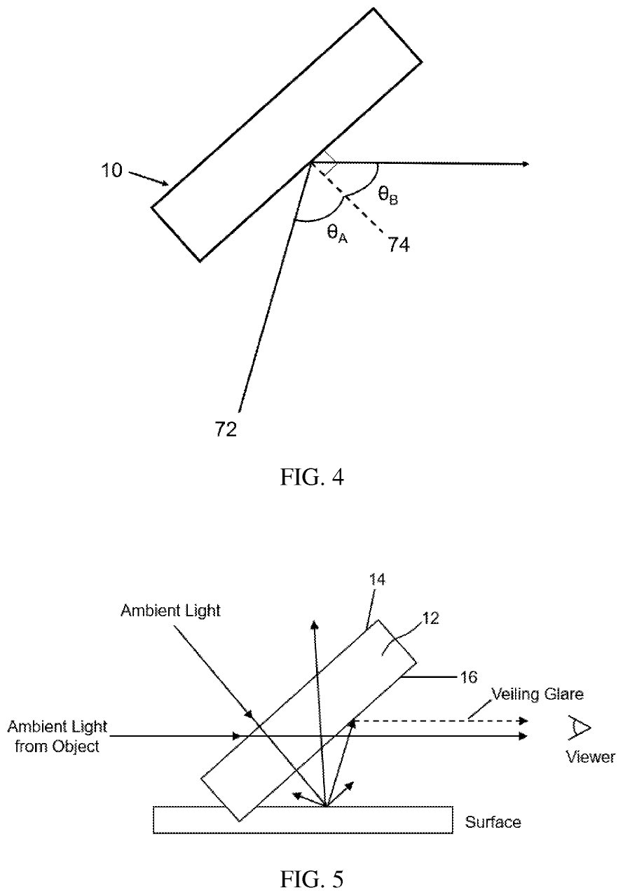

Referring to FIG. 4, the functional coating 30 is configured to reflect at least 10%, such as at least 13%, or such as at least 13.5% of p-polarized radiation 72 that contacts the functional coating 30 at an incident angle (θ_{A}) of 60° relative to normal 74 of the coated article 10. The functional coating 30 reflects the p-polarized radiation 72 at a reflected angle (θ_{B}) ranging from 40° to 70° relative to normal 74 of the coated article 10.

As used herein “p-polarized radiation” means that the radiation has an electric field that is polarized parallel to the plane of incidence. The “angle of incidence” is defined as the angle between a ray of radiation incident on a surface to a line normal to the surface at the point of incidence.

The p-polarized radiation 72 can be electromagnetic radiation, or any other desired form of radiation. For example, the p-polarized radiation 72 may be visible radiation, ultraviolet radiation, infrared radiation, and the like, as well as combinations thereof.

For example, the p-polarized radiation 72 may be visible radiation. For example, the p-polarized radiation 72 may comprise wavelengths ranging from 400 nm to 700 nm, or such as from 445 nm to 654 nm.

The functional coating 30 may be configured to reflect at least 10.0% and no more than 20.0% of p-polarized radiation 72 that contacts the functional coating 30 at the incident angle (θ_{A}) of 60° relative to normal 74 of the coated article 10, with the reflected p-polarized radiation comprising wavelengths ranging from 646 nm to 654 nm. The functional coating 30 may be configured to reflect at least 10.0% and no more than 20.0% of p-polarized radiation 72 that contacts the functional coating 30 at the incident angle (θ_{A}) of 60° relative to normal 74 of the coated article 10, with the reflected p-polarized radiation comprising wavelengths ranging from 515 nm to 525 nm. The functional coating 30 may be configured to reflect at least 10.0% and no more than 21.5% of p-polarized radiation 72 that contacts the functional coating 30 at the incident angle (θ_{A}) of 60° relative to normal 74 of the coated article 10, with the reflected p-polarized radiation comprising wavelengths ranging from 445 nm to 465 nm. The functional coating 30 reflects the p-polarized radiation 72 at the reflected angle (θ_{B}) ranging from 40° to 70° relative to normal 74 of the coated article 10.

The functional coating 30 may be configured to reduce veiling glare. As shown in FIG. 5, veiling glare occurs when ambient light passes through a substrate 12, such as from the No. 1 surface 14 through the No. 2 surface 16, reflects off a surface and back onto the No. 2 surface 16 of the substrate 12, and then reflects off the No. 2 surface 16 of the substrate 12 and into the eyes of a viewer. The viewer sees a virtual image of the lit surface beyond the No. 1 surface 14 of the substrate 12 that “veils” or impedes the ability to discern the object ahead of the No. 1 surface 14 of the substrate 12. Veiling glare is exacerbated when substrates 12 are held at a steep slope or when the surface is a light-colored or has glossy finish. When the functional coating 30 is positioned over at least a portion of the No. 2 surface 16 of the substrate 12, the veiling glare of the coated article 10 is reduced, as compared to an article having a double silver layer functional coating not according to the invention. For example, the coated article 10 may comprise a veiling glare, as determined relative to normal 74 of the coated article 10, of less than or equal to 22%, such as less than or equal to 20%, or such as less than equal to 19%.

The coated article 10 may comprise a visible light transmittance (LTA) of at least 70%. For example, the coated article 10 may comprise a LTA that is greater than 70%, such as greater than 71%, or such as greater than 72%.

The functional coating 30 may provide the coated article 10 with an exterior reflected L*(RgL*) of no more than 55, as determined relative to normal 74 of the coated article 10. For example, the functional coating 30 may provide the coated article 10 with a RgL* in a range of from 35 to 55, such as from 40 to 54, or such as from 50 to 52, as determined relative to normal 72 of the coated article 10. When the functional coating 30 is positioned over at least a portion of the No. 2 surface 16 of the substrate 12, the RgL* of the coated article 10 is lower than an article having a double silver layer functional coating not according to the invention. The functional coating 30 may provide the coated article 10 with an exterior reflected color a*(Rga*) in a range of from 0 to −10, such as from −1 to −8, such as from −1.2 to −7.0, such as from −1.5 to −6.8, or such as from −1.7 to −5.0, as determined relative to normal 74 of the coated article 10. The functional coating 30 may provide the coated article 10 with an exterior reflected color b*(Rgb*) in a range of from 1 to −20, such as from 0 to −19, such as from −2.0 to −10, such as from −10 to −20, or such as from −15 to −19, as determined relative to normal 74 of the coated article 10.

As will be appreciated by one of skill in the art, the color of an object, and in particular glass, is highly subjective. Observed color will depending on the lighting conditions and preferences of the observer. In order to evaluate color on a quantitative basis, several color order systems have been developed. In one color order system, the color is specified in terms of hue and lightness. This system is commonly referred to as the CIELAB color system. Hue distinguishes colors such as red, yellow, green and blue. Lightness, or value, distinguishes the degree of lightness or darkness. The numerical values of these characteristics, which are identified as L*, a* and b*, are calculated from the tristimulus values (X, Y, Z). L* indicates the lightness or darkness of the color and represents the lightness plane on which the color resides. a* indicates the position of the color on a red (+a*) green (−a*) axis. b* indicates the color position on a yellow (+b*) blue (−b*) axis. When the rectangular coordinates of the CIELAB system are converted into cylindrical polar coordinates, the resulting color system is known as the CIELCH color system which specifies color in terms of lightness (L*), and hue angle (H°) and chroma (C*). L* indicates the lightness or darkness of the color as in the CIELAB system. Chroma, or saturation or intensity, distinguishes color intensity or clarity (i.e., vividness vs. dullness) and is the vector distance from the center of the color space to the measured color. The lower the chroma of the color, i.e., the less its intensity, the closer the color is to being a so-called neutral color. With respect to the CIELAB system, C*=(a*²+b*²)^{1/2}. Hue angle distinguishes colors such as red, yellow, green and blue and is a measure of the angle of the vector extending from the a*, b* coordinates through the center of the CIELCH color space measured counterclockwise from the red (+a*) axis. However, it is to be understood that this the disclosed colors could be defined by any conventional system.

Referring to 6A and 6B, the coated article 10 may further comprise a second substrate 18 and an interlayer 24. The second substrate 18 comprises a No. 3 surface 20 and a No. 4 surface 22. The No. 4 surface 22 is opposite the No. 3 surface 20. The second substrate 18 may be any of the substrates described herein with respect to the first substrate 12. The No. 3 surface 20 of the second substrate 18 faces the functional coating 30 on No. 2 surface 16 of the first substrate 12, with the interlayer 24 positioned between and in direct contact with the No. 3 surface 20 of the second substrate 18 and the functional coating 30, such as the second film 60 of the third dielectric layer 56 or the optional outermost protective coating 62, on the No. 2 surface 16 of the first substrate 12.

The interlayer 24 can be of any desired material and can include one or more layers or plies. The interlayer 24 can be a polymeric or plastic material, such as, for example, polyvinylbutyral (PVB), plasticized polyvinyl chloride, or multi-layered thermoplastic materials including polyethyleneterephthalate, etc. Suitable interlayer materials are disclosed, for example but not to be considered as limiting, in U.S. Pat. Nos. 4,287,107 and 3,762,988, which are incorporated by reference herein. The interlayer 24 can also be a sound absorbing or attenuating material as described, for example, in U.S. Pat. No. 5,796,055, which is incorporated by reference herein. The interlayer 24 can have a solar control coating provided thereon or incorporated therein or can include a colored material to reduce solar energy transmission. The interlayer 24 may be any suitable thickness to hold the first substrate 12 and the second substrate 18 together.

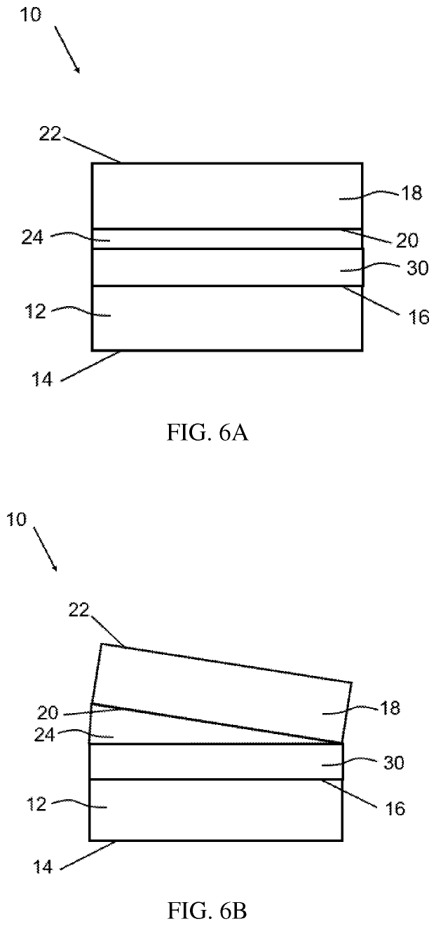

The interlayer 24 can be a layer having a uniform thickness, as shown in FIG. 6A. The interlayer 24 may be a uniform thickness because other aspects of the design of transparency 10 may counteract ghosting.

Alternatively, the interlayer 24 can be non-parallel relative to the second substrate 18. For example, interlayer 24 can be wedge-shaped, as shown in FIG. 6B. The wedge-shape of interlayer 24 can be configured such that radiation reflects off of the coated article 10 at the proper angle to avoid ghosting (e.g., to avoid seeing multiple images based on the direction of the light reflecting off of coated article 10 converging at different points).

When the coated article 10 further comprises the second substrate 18 and the interlayer 24, the coated article 10 may be vehicle transparency, such as a windshield.

The present invention is also directed to a method of making a coated article 10. A first substrate 12 having a No. 1 surface 14 and a No. 2 surface 16 opposite the No. 1 surface 14 is provided. The first substrate 12 may be any of the first substrates 12 described herein. A functional coating 30 is applied over at least a portion of the No. 2 surface 16 of the first substrate 12. The functional coating 30 may comprise, consist essentially of, or consist of any of the functional coatings described herein.

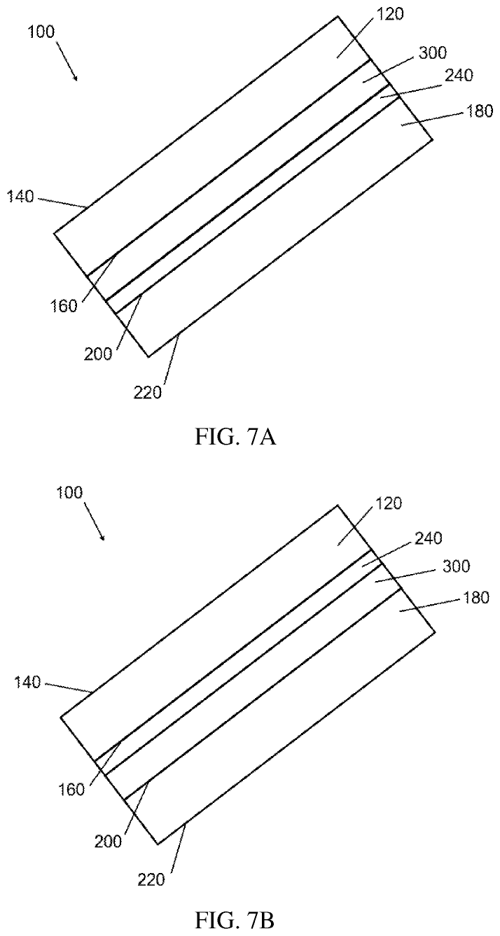

The present invention is also related to a method of projecting an image in a head-up display (HUD). A laminate 100 comprising a first substrate 120 comprising a No. 1 surface 140 and a No. 2 surface 160 opposite the No. 1 surface 140, a second substrate 180 comprising a No. 3 surface 200 and a No. 4 surface 220 opposite the No. 3 surface 200, wherein the No. 2 surface 160 faces the No. 3 surface 200, an interlayer 240 positioned between the No. 2 surface 160 and the No. 3 surface 200, and a functional coating 300 positioned over at least a portion of the No. 2 surface 160 or the No. 3 surface 200 is provided (FIGS. 7A and 7B). The first substrate 120 may be any of the first substrates 12 described herein. The second substrate 180 may be any of the second substrates 18 described herein. The interlayer 240 may be any of the interlayers 24 described herein. The functional coating 300 may comprise, consist essentially of, or consist of any of the functional coatings 30 described herein. A radiation source 70 that emits p-polarized radiation 72 is directed at an area of an inner side of the laminate 100, such as the No. 4 surface 22 of the second substrate 18. The radiation source 70 is positioned at an angle of 60° relative to normal 74 of the laminate 100. The radiation emitted from the radiation source 70 is reflected as an image through the No. 4 surface 220 of the second substrate 180.

The functional coating 300 may be positioned on the No. 2 surface 160 of the first substrate 120 (FIG. 7A). When the functional coating 300 is positioned on the No. 2 surface 160 of the first substrate 120, the interlayer 240 is positioned between and in direct contact with the No. 3 surface 200 of the second substrate 180 and the functional coating 300, such as the second film of the third dielectric layer or the optional outermost protective coating.

The functional coating 300 may be positioned on the No. 3 surface 200 of the second substrate 180 (FIG. 7B). When the functional coating 300 is positioned on the No. 3 surface 200 of the second substrate 180, the interlayer 240 is positioned between and in direct contact with the No. 2 surface 160 of the first substrate 120 and the functional coating 300, such as the second film of the third dielectric layer or the optional outermost protective coating.

The laminate 100 can have any desired visible light, infrared radiation, or ultraviolet radiation transmission and reflection. For example, the laminate 100 can have a visible light transmission of any desired amount, e.g., greater than 0% to 100%, e.g., greater than 70%. For windshield and front sidelight areas in the United States, the visible light transmission is typically greater than or equal to 70%. For privacy areas, such as rear seat sidelights and rear windows, the visible light transmission can be less than that for windshields, such as less than 70%.

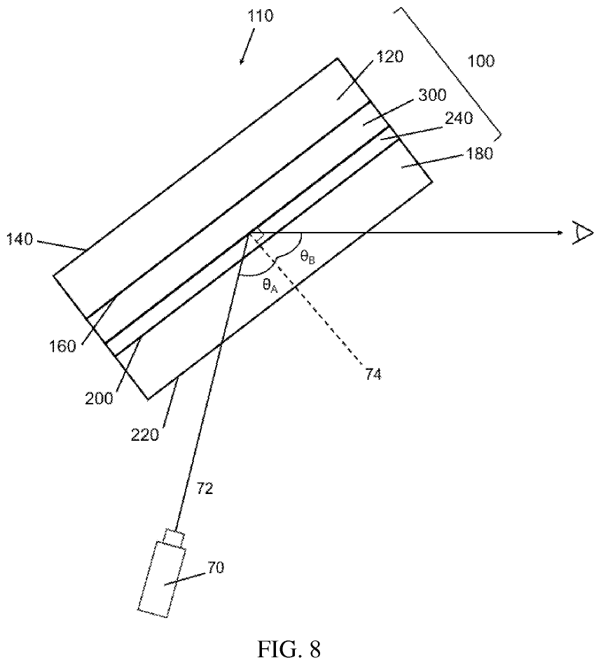

An exemplary HUD system 110 according to the present invention is provided in FIG. 8. In the laminate 100 shown in FIG. 8, the functional coating 300 is positioned on the No. 2 surface 160 of the first substrate 120, but could alternatively be positioned on the on the No. 3 surface 200 of the second substrate 180.

A radiation source 70 may emit electromagnetic radiation, or any other desired form of radiation. The radiation source 70 can emit radiation across the entire radiation spectrum, or across only a portion thereof. For example, the radiation source 70 can emit radiation across the visible spectrum, across the ultraviolet radiation spectrum, across the infrared radiation spectrum, and the like, as well as combinations thereof. The radiation source 70 may emit white light as the radiation.

The radiation source 70 emits the p-polarized radiation 72. The p-polarized radiation 72 emitted by the radiation source 70 may be visible radiation and may comprise wavelengths ranging from 400 nm to 700 nm, or such as from 445 nm to 654 nm.

The radiation source 70 may also emit s-polarized radiation. As used herein, “s-polarized radiation” means that the radiation has an electric field that is polarized perpendicular to the plane of incidence.

The radiation source 70 may be used in combination with a polarized filter. The polarized filter may be positioned between the radiation source 70 and the laminate 100. The polarized filter may be designed to permit at least a portion of the p-polarized radiation 72, and optionally at least a portion of the s-polarized radiation, therethrough. The polarized filter may be designed to permit only p-polarized radiation 72 to pass therethrough. The polarized filter may be designed to filter at least a portion of s-polarized radiation, such that the filtered portion cannot pass therethrough. The polarized filter can further, alternatively, be designed to filter substantially all of the s-polarized radiation, such that substantially all of the s-polarized radiation cannot pass therethrough. Substantially all, in this context, means that the polarized filter filters at least 95% of the s-polarized radiation, such as at least 97% of the s-polarized radiation, such as at least 99% of the s-polarized radiation, or such as 100% of the s-polarized radiation.

The HUD system 110 may be a HUD system 110 for a vehicle, such as a HUD system in an automobile or aircraft. However, the display system can be any type of display projecting an image. Non-limiting examples of displays that can be considered the “display system” include advertising, promotional, or informational displays, and the like. The display system may project an image visible to humans (e.g., within the visible spectrum). Alternatively, the display system may project an image in a non-visible region of the electromagnetic spectrum.

When the radiation source 70 emits radiation directed at the laminate 100, such as at an area of an inner side of the laminate 100 (e.g., the No. 4 surface 220 of the second substrate 180), an image can be projected onto the area on an inner side of laminate 100, and the image can be viewable to eye of a user. The image of the display system can be static or dynamic. The image can include colors and can be a monochromatic image or a polychromatic image.

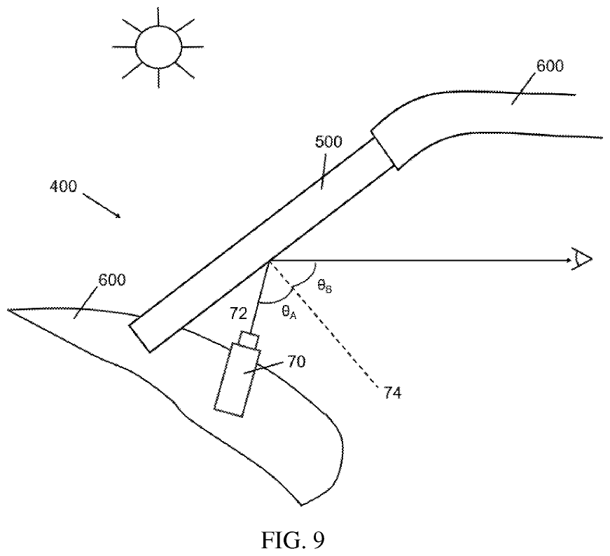

The present invention is also directed to a vehicle HUD system 400 and vehicle 600 that includes the HUD system 400 (FIG. 9). The vehicle HUD system 400 comprises a radiation source 70 and a windshield 500. The radiation source 70 is configured to emit radiation comprising p-polarized radiation 72 at an incident angle (θ_{A}) of 60° relative to normal 74 of the windshield 500. The windshield 500 may be any of the laminates 100 described herein. The windshield 500 includes a first substrate having a No. 1 surface and a No. 2 surface opposite the No. 1 surface, a second substrate having a No. 3 surface and a No. 4 surface opposite the No. 3 surface, an interlayer positioned between the No. 2 surface and the No. 3 surface, and the functional coating positioned on the No. 3 surface of the second substrate. The first and second substrates may be any of the first and second substrates 12, 18 described herein. The interlayer may be any of the interlayers 24 described herein. The functional coating may comprise, consist essentially of, or consist of any of the functional coatings 30, 300 described herein. The radiation source 70 may be any of the radiation sources 70 described herein.

The No. 1 surface of the first substrate (or first ply) faces the vehicle exterior, i.e., is an outer major surface, and the opposed No. 2 surface of the first substrate (or first ply) faces the vehicle interior, i.e., is an inner major surface. The No. 3 surface of the second substrate (or second ply) faces the vehicle exterior, i.e., an outer major surface, and the opposed No. 4 surface of the second substrate faces the vehicle interior, i.e., is an inner major surface. This numbering of the substrate surfaces is in keeping with conventional practice in the automotive art. The first and second substrates are bonded together using the interlayer. Although not required, a conventional edge sealant can be applied to the perimeter of the windshield during and/or after lamination in any desired manner. A decorative band, e.g., an opaque, translucent or colored shade band, such as a ceramic band, can be provided on a surface of at least one of the substrates, for example around the perimeter of the No. 2 surface of the first substrate. A bus bar assembly may be in electrical contact with the functional coating. The bus bar assembly may be connected to an electrical power source which may be a conventional vehicle alternator, e.g., configured to supply approximately 14 volts.

The functional coating may be positioned on the No. 2 surface of the first substrate of the windshield 500. When the functional coating is positioned on the No. 2 surface of the first substrate of the windshield 500, the interlayer is positioned between and in direct contact with the No. 3 surface of the second substrate and the functional coating, such as the second film of the third dielectric layer or the optional outermost protective coating.

The functional coating may be positioned on the No. 3 surface of the second substrate of the windshield. When the functional coating is positioned on the No. 3 surface of the second substrate of the windshield 500, the interlayer is positioned between and in direct contact with the No. 2 surface of the first substrate and the functional coating, such as the second film of the third dielectric layer or the optional outermost protective coating.

The functional coating of the windshield 500 is configured to reflect at least 10.0%, such as at least 13%, or such as at least 13.5%, of p-polarized radiation 72 that contacts the functional coating at an incident angle (θ_{A}) of 60° relative to normal 74 of the windshield 500, wherein the functional coating reflects the p-polarized radiation at a reflected angle (θ_{B}) ranging from 40° to 70° relative to normal 74 of the windshield 500.

The functional coating of the windshield 500 is configured to reflect at least 10.0% and no more than 20.0% of p-polarized radiation 72 that contacts the functional coating at the incident angle (θ_{A}) of 60° relative to normal 74 of the windshield 500, with the reflected p-polarized radiation comprising wavelengths ranging from 646 nm to 654 nm. The functional coating of the windshield 500 is configured to reflect at least 10.0% and no more than 20.0% of p-polarized radiation 72 that contacts the functional coating at the incident angle (θ_{A}) of 60° relative to normal 74 of the windshield 500, with the reflected p-polarized radiation comprising wavelengths ranging from 515 nm to 525 nm. The functional coating of the windshield 500 is configured to reflect at least 10.0% and no more than 21.5% of p-polarized radiation 72 that contacts the functional coating 300 at the incident angle (θ_{A}) of 60° relative to normal 74 of the windshield 500, with the reflected p-polarized radiation comprising wavelengths ranging from 445 nm to 465 nm. The functional coating of the windshield 500 reflects p-polarized radiation 72 at the reflected angle (θ_{B}) ranging from 40° to 70° relative to normal 74 of the windshield 500.

When the functional coating is included in the windshield 500, the veiling glare of the windshield 500 is reduced, as compared to a windshield having a double silver layer functional coating not according to the invention. For example, the windshield 500 may comprise a veiling glare, as determined relative to normal 74 of the windshield 500, of less than or equal to 22%, such as less than or equal to 20%, or such as less than equal to 19%.

The vehicle HUD display system 400 may project an image visible to humans (e.g., within the visible spectrum). Alternatively, the vehicle HUD display system 400 may project an image in a non-visible region of the electromagnetic spectrum.

The radiation source 70 can emit radiation that is directed off of windshield 500, such that at least a portion of radiation is reflected off of windshield 500 and is directed to an eye of a user. The portion of the radiation not reflected off of the windshield 500, can be refracted, absorbed, or otherwise transmitted through windshield 500.

The user of the vehicle HUD system 400 may be wearing polarized sunglasses and radiation that is directed to the eye of the user may be directed toward the polarized sunglasses. For example, the polarized sunglasses can filter s-polarized radiation, such that at least a portion of the s-polarized radiation cannot pass therethrough.

When the radiation source 70 emits radiation directed at windshield 500, such as at an area of an inner side of the windshield 500 (e.g., the No. 4 surface of the second substrate of the windshield), an image can be projected onto the area on an inner side of windshield 500, and the image can be viewable to eye of a user. The image of the HUD display system 400 can be static or dynamic. The image can include colors and can be a monochromatic image or a polychromatic image. The radiation source 70 can be directed at the windshield 500 to display an image so that the driver (or other user) may see the image while operating the vehicle.

The following Examples illustrate various embodiments of the invention. However, it is to be understood that the invention is not limited to these specific embodiments.

### Examples

Table 1 shows exemplary functional coatings. The reported thicknesses are in Angstroms (Å). The first protective film of the outermost protective coating is 85 wt. % silicon and 15 wt. % aluminum (SiAl). The functional coating was modeled on the No. 2 surface of a glass substrate.

| Layer | Composition | Sample 1 | Sample 2 | Sample 3 |
|---|---|---|---|---|
| First Dielectric Layer | First Film: Tin Oxide | 177.3 | 161.6 | 161.6 |
| | Second Film: Zinc Stannate | 152.9 | 100.3 | 100.5 |
| | Third Film: Zinc Oxide | 72.5 | 72.5 | 72.5 |
| First Metallic Layer | Silver | 141.8 | 146.0 | 146.7 |
| Second Dielectric Layer | First Film: Zinc Oxide | 118.5 | 118.5 | 118.5 |
| | Second Film: Zinc Stannate | 746.7 | 697.9 | 709.1 |
| | Third Film: Zinc Oxide | 101.3 | 101.3 | 101.3 |
| Second Metallic Layer | Silver | 78.4 | 82.9 | 81.8 |
| Third Dielectric Layer | First Film: Zinc Oxide | 72.9 | 72.9 | 72.9 |
| | Second Film: Zinc Stannate | 300.5 | 279.6 | 278.4 |
| Outermost Protective | First protective film: SiAl | 514.0 | 514.0 | 514.0 |
| Coating | Second protective film: Silica | 39.5 | 39.5 | 39.5 |

The functional coatings of Samples 1-3 were then modeled as Laminates 1-3, respectively, having the following structure:
1^{st} Glass Substrate/Functional Coating of Samples 1, 2, or 3/Interlayer/2^{nd} Glass Substrate, wherein the No. 3 surface of the second glass substrate was in contact with the interlayer and each of the No. 1 surface of the first glass substrate and the No. 4 surface of the second glass substrate contacted air. The interlayer was modeled as a polyvinyl butyral (PVB) interlayer.

P-polarized radiation having wavelengths ranging from 400 nm to 700 (e.g., in the visible spectrum) was modeled to be directed at the No. 4 surface of the laminate at an incident angle of 60° relative to normal of the laminate.

The resulting properties of Laminates 1-3 are provided in the following table. “LTA” is the visible transmittance of the laminate. The spectral reflectance of p-polarized radiation in a wavelength range of 445 nm to 465 nm, the spectral reflectance of p-polarized radiation in a wavelength range of 515 nm to 525 nm, and the spectral reflectance of p-polarized radiation in a wavelength range of 646 nm to 654 nm for each of Laminates 1-3, as measured at a reflected angle ranging from 40° to 70° relative to normal of the laminate, are provided in the following table. As used herein, “spectral reflectance” is the portion of the incident p-polarized radiation that is reflected by the laminate as a function of wavelength. “pRfY” in the following table is the integrated value with a normalized function of the reflected p-polarized radiation across the wavelength ranges of 445 nm to 465 nm, 515 nm to 525 nm, and 646 nm to 654 nm, as measured at a reflected angle ranging from 40° to 70° relative to normal of the laminate.

| | | | Spectral Reflectance of | | | |
|---|---|---|---|---|---|---|
| | | Veiling | p-Polarized Radiation | | | |
| Laminate | LTA | Glare | 445-465 nm | 515-525 nm | 646-654 nm | pRfY |
| 1 | 72.0% | 20.4% | 20%-21.5% | 15.5%-16.5% | 9%-10% | 12.8% |
| 2 | 72.5% | 19.7% | 19%-20% | 14-15% | 10.5%-12.5% | 12.4% |
| 3 | 71.5% | 20.6% | 19%-20.5% | 15-16% | 10.5%-12.5% | 13.5% |

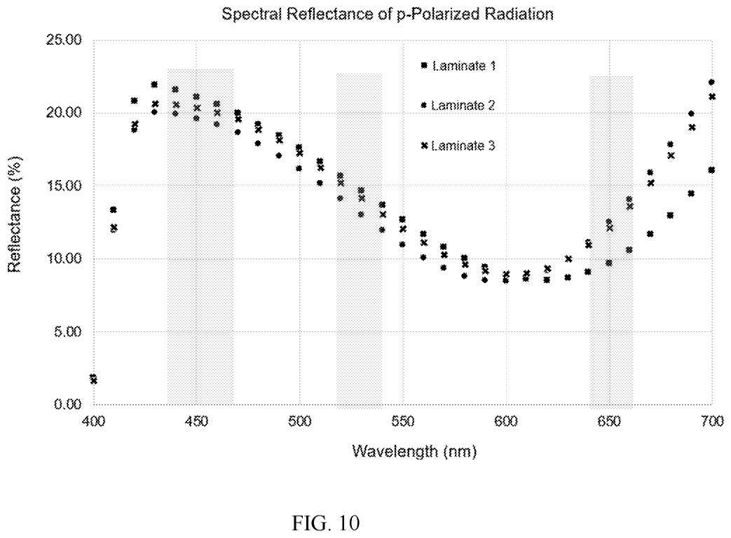

The spectral reflectance of p-polarized radiation of each of Laminates 1-3, as measured at a reflected angle ranging from 40° to 70° relative to normal of the laminate, is provided in FIG. 10.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A coated article comprising:
a first substrate having a No. 1 surface and a No. 2 surface opposite the No. 2 surface; and
a functional coating positioned over at least a portion of the No. 2 surface, the functional coating comprising:
a first dielectric layer over at least a portion of the No. 2 surface, wherein the first dielectric layer comprises a first film comprising tin oxide and a second film over at least a portion of the first film, and wherein the first dielectric layer comprises a total thickness in a range of from 299 Angstroms (Å) to 447 Å;
a first metallic layer over at least a portion of the first dielectric layer, wherein the first metallic layer comprises a thickness in a range of from 125 Å to 162 Å;
a second dielectric layer over at least a portion of the first metallic layer, wherein the second dielectric layer comprises a total thickness in a range of from 835 Å to 1052 Å;
a second metallic layer over at least a portion of the second dielectric layer, wherein the second metallic layer comprises a thickness in a range of from 70 Å to 95 Å; and
a third dielectric layer over at least a portion of the second metallic layer, wherein the third dielectric layer comprises a total thickness in a range of from 315 Å to 410 Å;
wherein the functional coating is configured to reflect at least 10% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

2. The coated article of claim 1, wherein the p-polarized radiation comprises wavelengths ranging from 445 nanometers (nm) to 654 nm.

3. The coated article of claim 1, wherein the functional coating consists of two metallic layers.

4. The coated article of claim 1, wherein the first film of the first dielectric layer comprises a thickness in a range of from 235 Å to 365 Å, and
wherein the second film of the first dielectric layer comprises zinc oxide, wherein the second film of the first dielectric layer comprises a thickness in a range of from 64 Å to 82 Å.

5. The coated article of claim 1, wherein the first dielectric layer further comprises a third film over at least a portion of the second film, wherein when the first dielectric layer comprises the third film over at least a portion of the second film:
the first film comprises tin oxide, wherein the first film comprises a thickness in a range of from 145 Å to 195 Å;
the second film comprises zinc stannate, wherein the second film comprises a thickness in a range of from 90 Å to 170 Å; and
the third film comprises zinc oxide, wherein the third film comprises a thickness in a range of from 64 Å to 82 Å.

6. The coated article of claim 1, wherein the first metallic layer comprises a thickness in a range of from 130 Å to 158 Å.

7. The coated article of claim 1, wherein the second dielectric layer comprises:
a first film comprising zinc oxide over at least a portion of the first metallic layer, wherein the first film comprises a thickness in a range of from 105 Å to 130 Å;
a second film comprising zinc stannate over at least a portion of the first film, wherein the second film comprises a thickness in a range of from 640 Å to 810 Å; and
a third film comprising zinc oxide over at least a portion of the second film, wherein the third film comprises a thickness in a range of from 90 Å to 112 Å.

8. The coated article of claim 1, wherein the second metallic layer comprises a thickness in a range of from 72 Å to 90 Å.

9. The coated article of claim 1, wherein the functional coating further comprises a first primer layer over at least a portion of the first metallic layer and second primer layer over at least a portion of the second metallic layer,
wherein the first primer layer and the second primer layer are each independently selected from the group consisting of zinc, aluminum, vanadium, tungsten, tantalum, niobium, zirconium, manganese, chromium, tin, nickel, germanium, magnesium, molybdenum, silver, silicon carbon, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof, wherein the first primer layer and the second primer layer are each independently deposited as a metal and subsequently oxidized, and
wherein the first primer layer and the second primer layer each independently comprise a thickness in a range of from 5 Å to 60 Å.

10. The coated article of claim 1, wherein the third dielectric layer comprises:
a first film comprising zinc oxide over at least a portion of the second metallic layer, wherein the first film comprises a thickness in a range of from 65 Å to 80 Å; and
a second film comprising zinc stannate or tin oxide over at least a portion of the first film, wherein the second film comprises a thickness in a range of from 250 Å to 330 Å.

11. The coated article of claim 1, further comprising an outermost protective coating over at least a portion of the functional coating, wherein the outermost protective coating comprises at least one protective layer, wherein the at least one protective layer comprises at least one of Si₃N₄, SiON, SiAlN, SiAlON, titania, alumina, silica, or zirconia.

12. The coated article of claim 1, wherein the coated article comprises a veiling glare, as determined relative to normal of the coated article, of less than or equal to 22%.

13. The coated article of claim 1, wherein the functional coating is configured to reflect at least 10.0% and no more than 20.0% of p-polarized radiation that contacts the functional coating at the incident angle of 60° relative to normal of the coated article, wherein the functional coating reflects the p-polarized radiation at the reflected angle ranging from 40° to 70° relative to normal of the coated article, wherein the reflected p-polarized radiation comprises wavelengths ranging from 646 nm to 654 nm.

14. The coated article of claim 1, wherein the functional coating is configured to reflect at least 10.0% and no more than 20.0% of p-polarized radiation that contacts the functional coating at the incident angle of 60° relative to normal of the coated article, wherein the functional coating reflects the p-polarized radiation at the reflected angle ranging from 40° to 70° relative to normal of the coated article, wherein the reflected p-polarized radiation comprises wavelengths ranging from 515 nm to 525 nm.

15. The coated article of claim 1, wherein the functional coating is configured to reflect at least 10.0% and no more than 21.5% of p-polarized radiation that contacts the functional coating at the incident angle of 60° relative to normal of the coated article, wherein the functional coating reflects the p-polarized radiation at the reflected angle ranging from 40° to 70° relative to normal of the coated article, wherein the reflected p-polarized radiation comprises wavelengths ranging from 445 nm to 465 nm.

16. The coated article of claim 1, further comprising a second substrate comprising a No. 3 surface and a No. 4 surface opposite the No. 3 surface, and an interlayer positioned between and in direct contact with the No. 3 surface and the functional coating on the No. 2 surface.

17. A method of making a coated article, the method comprising:
providing a first substrate having a No. 1 surface and a No. 2 surface opposite the No. 1 surface;
applying a functional coating over at least a portion of the No. 2 surface, wherein applying the functional coating comprises:
forming a first dielectric layer over at least a portion of the No. 2 surface, wherein forming the first dielectric layer comprises:
forming a first film comprising tin oxide over at least a portion of the No. 2 surface, and
forming a second film over at least a portion of the first film,
wherein the first dielectric layer comprises a total thickness in a range of from 299 Å to 447 Å;
forming a first metallic layer over at least a portion of the first dielectric layer, wherein the first metallic layer comprises a thickness in a range of from 125 Å to 162 Å;
forming a second dielectric layer over at least a portion of the first metallic layer, wherein the second dielectric layer comprises a total thickness in a range of from 835 Å to 1052 Å;
forming a second metallic layer over at least a portion of the second dielectric layer, wherein the second metallic layer comprises a thickness in a range of from 70 Å to 95 Å; and
forming a third dielectric layer over at least a portion of the second metallic layer, wherein the third dielectric layer comprises a total thickness in a range of from 315 Å to 410 Å;
wherein the functional coating is configured to reflect at least 10.0% of p-polarized radiation that contacts the functional coating at an incident angle of 60° relative to normal of the coated article, wherein the functional coating reflects the p-polarized radiation at a reflected angle ranging from 40° to 70° relative to normal of the coated article.

18. The method of claim 17, wherein the functional coating is configured to reflect at least 13.5% of p-polarized radiation that contacts the functional coating at the incident angle of 60° relative to normal of the coated article, wherein the functional coating reflects the p-polarized radiation at the reflected angle ranging from 40° to 70° relative to normal of the coated article.

19. The method of claim 17, wherein the p-polarized radiation comprises wavelengths ranging from 445 nm to 654 nm.

20. A vehicle head-up display system comprising:
a radiation source; and
a windshield comprising:
a first substrate having a No. 1 surface and a No. 2 surface opposite the No. 1 surface;
a second substrate having a No. 3 surface and a No. 4 surface opposite the No. 3 surface;
an interlayer positioned between the No. 2 surface and the No. 3 surface; and
a functional coating positioned on the No. 3 surface, the functional coating comprising:
a first dielectric layer over at least a portion of the No. 3 surface, wherein the first dielectric layer comprises a first film comprising tin oxide over at least a portion of the No. 3 surface and a second film over at least a portion of the first film, and wherein the first dielectric layer comprises a total thickness in a range of from 299 Å to 447 Å;
a first metallic layer over at least a portion of the first dielectric layer, wherein the first metallic layer comprises a thickness in a range of from 125 Å to 162 Å;
a second dielectric layer over at least a portion of the metallic layer, wherein the second dielectric layer comprises a total thickness in a range of from 835 Å to 1052 Å;
a second metallic layer over at least a portion of the second dielectric layer, wherein the second metallic layer comprises a thickness in a range of from 70 Å to 95 Å; and
a third dielectric layer over at least a portion of the second metallic layer, wherein the third dielectric layer comprises a total thickness in a range of from 315 Å to 410 Å;
wherein the radiation source is configured to emit radiation comprising p-polarized radiation at an incident angle of 60° relative to normal of the windshield; and
wherein the functional coating is configured to reflect at least 10.0% of the p-polarized radiation at a reflected angle ranging from 40° to 70° relative to normal of the windshield.
